(19) United States
(12) Patent Application Publication
(10) Pub. No.: US 2004/0215708 A1
(43) Pub. Date: Oct. 28, 2004

(54) Content history log collecting system

(76) Inventors: Akio Higashi, Takatsuki-shi (JP); Kouji Miura, Matsubara-shi (JP); Masaya Yamamoto, Hirakata-shi (JP); Hiroki Murakami, Suita-shi (JP); Katsumi Tokuda, Ikeda-shi (JP)

Correspondence Address: WENDEROTH, LIND & PONACK, L.L.P., 2033 K STREET N. W., SUITE 800, WASHINGTON, DC, 20006-1021, US

(21) Appl. No.: 10/786,114

(22) Filed: Feb. 26, 2004

(30) Foreign Application Priority Data
Jan. 28, 2003 (JP) 2003-052761

(51) Int. Cl. G06F 15/16

(52) U.S. Cl. 709/201

(57) ABSTRACT

A content history log collecting system comprising a server apparatus for distributing a content to a terminal apparatus and collecting a content history log from the terminal apparatus and a terminal apparatus for using the content, wherein the server apparatus includes an adding unit operable to add, to the content, time information indicating a temporal scale of the content, and a content sending unit operable to send, to the terminal apparatus, the content to which the time information is added, and the terminal apparatus includes a content using unit operable to use the content sent from the server apparatus, a generating unit operable to generate section information indicating a section in the content that has been actually used by the content using unit based on the time information of the content, and a sending unit operable to send the section information to the server apparatus.

### BACKGROUND OF THE INVENTION

(1) Field of the Invention

The present invention relates to a system for distributing digital contents such as video and music from a server apparatus via a communication network or broadcasting and enabling a user to use the digital contents in a terminal apparatus, especially a system and a device that allows a terminal apparatus to obtain digital content history logs and send the history logs to the server apparatus and allows a server apparatus to collect user's history logs of the digital contents.

(2) Description of the Related Art

A system called content distribution system is in the stage of practical use recently, the content distribution system makes it possible to distribute digital contents (simply written as “contents” from here) such as music, video, game and the like from a server apparatus to a terminal apparatus via a communication network such as the Internet or digital broadcasting and use the contents using the terminal apparatus. In generally-used content distribution systems, copy right protection technique is used so as to protect a copy right of contents and prevent unpermitted use of contents by a malicious user or others. More specifically, copy right protection technique is technique for securely controlling content use such as the case where a user plays back contents or copies it to a storage medium using encryption/decryption technique or the like.

For example, in the patent literature 1 and the patent literature 2, a system for recording times and time of playing back contents or copying contents to a storage media and the like as history logs and periodically sending history logs to a specified server apparatus is written as an example of a content history log collecting system.

In this way, in the conventional content history log collecting system, it is possible to send history logs such as content use times and time by a user to a server apparatus.

[Patent Literature 1]

Japanese Laid-Open Patent application No. 2000-564425

[Patent Literature 2]

Japanese Laid-Open Patent application No. 2001-160003

However, the conventional content history log collecting system does not allow a content provider or a service provider to securely grasp which part of the contents is viewed by a user (viewed section in the content), in other words, obtain a history log without any detailed manipulation.

Especially, in the case of Moving Picture Experts Group (MPEG)-2 Systems or the like, there is a problem that there exists time information such as Presentation Time Stamp located in the header part of the PES packet in the content format but the time information is the one assigned so as to secure the synchronization of a plurality of Elementary Streams (ES) such as video and sound, and thus it is impossible to change the time information flexibly so as to grasp the history logs. Note that the MPEG-2 Systems is prescribed as the ISO/IEC 13818-1 that is an international standard.

### SUMMARY OF THE INVENTION

The present invention is for solving a conventional problem like this and an object of the present invention is to provide a content history log collecting system capable of obtaining important information such as a rating per minute or an average rating by recording time information assigned to contents securely as a history log in a terminal for using contents and enabling a content provider or a service provider to grasp which part of contents is used by a user using this time information and.

Another object of the present invention is to provide a content history log collecting system that is highly compatible with existing systems even in the case of the MPEG-2 Systems or the like where time information is included in a content format and it is difficult to flexibly change the time information when using it because of its system.

Further, another object is to obtain history logs of only part of contents that has been viewed by a user by performing a control for not obtaining any history log in the case where a terminal apparatus cannot perform content playback or decoding or is performing a special playback or the like.

The content history log collecting system capable of achieving the above-mentioned object comprises a server apparatus for distributing a content to a terminal apparatus and collecting a content history log from the terminal apparatus and a terminal apparatus for using the content, wherein the server apparatus includes: an adding unit operable to add, to the content, time information indicating a temporal scale of the content; and a content sending unit operable to send, to the terminal apparatus, the content to which the time information is added, and the terminal apparatus includes: a content using unit operable to use the content sent from the server apparatus; a generating unit operable to generate section information indicating a section in the content that has been actually used by the content using unit based on the time information of the content; and a sending unit operable to send the section information to the server apparatus.

Here, the content history log collecting system may be the one wherein the generating unit includes: a first detecting unit operable to detect a value of time information obtained when the content using unit starts using the content as starting time; a second detecting unit operable to detect a value of time information obtained when the content using unit finishes using the content as ending time; and a creating unit operable to create the section information based on the starting time detected by the first detecting unit and the ending time detected by the second detecting unit.

As the terminal apparatus with this structure uses the time information assigned to the contents, it is possible to generate the above-mentioned section information irrespective of the content distribution or storage type such as broadcast type, on-demand type or storage medium type. Also, the content provider or the service provider which has a server apparatus can grasp which part of the contents is actually used by a user based on the section information sent from the terminal apparatus and obtain, for example, a rating per minute, an average rating and the like.

Here, the content history log collecting system may be the one wherein the time information is added as any of following data: (a) program clock reference in transport stream packets; (b) presentation time stamp in PES packets; (c) decoding time stamp in PES packets; (d) private data in transport stream packets; and (e) private data in PES packets.

This structure makes it possible to use any of (a) to (e) mentioned above provided as a content format in the MPEG-2 Systems or the like as the time information, and thus it has an effect that it is highly compatible with existing systems.

Here, the content history log collecting system may be the one wherein the server apparatus further includes a content encrypting unit operable to encrypt at least part of the content, and the terminal apparatus further includes: a content decrypting unit operable to decrypt the encrypted content; and the content using unit uses the decrypted content.

Here, the content history log collecting system may be the one wherein the server apparatus further includes a binding unit operable to bind the time information to the content securely.

With this structure, as contents are encrypted and time information is securely bound to the contents, the server apparatus can securely obtain section information. In other words, the content provider or the service provider that has a server apparatus can improve the credibility of the rating or the like obtained from the section information and utilize it for the interest distribution of the contents.

Here, the content history log collecting system may be the one wherein the content decrypting unit performs an error detection based on the hash value and stops decrypting the content in the case where an error is detected.

Here, the content history log collecting system may be the one wherein the content decrypting unit performs an error detection based on the hash value, and the generating unit stops generating the section information in the case where an error is detected.

Here, the content history log collecting system may be the one wherein the terminal apparatus further includes a collecting unit operable to collect a content history log except the section information, and the collecting unit generates the content history log indicating that the time information is manipulated in the case where the error is detected.

This structure makes it possible to detect a manipulation of contents or time information. Further, for example, in the case where a manipulation is detected, this structure makes it possible to stop generating section information and generate content history logs indicating that a manipulation is detected.

Here, the content history log collecting system may be the one wherein, the content decrypting unit instructs the generating unit not to generate the section information in one of the case where the content decrypting unit fails to decrypt the content and the case where the content using unit fails to play back the content.

Here, the content history log collecting system may be the one wherein the terminal apparatus further includes a collecting unit operable to collect a content history log except the section information, and the content decrypting unit instructs the collecting unit to record a history log indicating that the decryption failed in one of the case where the content decrypting unit fails to decrypt the content and the case where the content using unit fails to play back the content.

When content decryption failed because of a manipulation or the like, this structure makes it possible to stop generating section information and record history logs indicating the fact.

Here, the content history log collecting system may be the one wherein the generating unit generates the section information excluding the special playback section in the case where content special playback is performed in the content using unit.

Here, the content history log collecting! system may be the one wherein the terminal apparatus further includes a collecting unit operable to collect a content history log except the section information, and the colleting unit, in the case where content special playback is performed in the content using unit, records a history log indicating that the special playback is performed.

With this structure, the generating unit can generate only sections on which normal playback is performed as section information because the generating unit excludes, from the section information, sections on which special playback such as pause, forwarding, rewinding (backwarding) or the like is performed. Also, the collecting unit can″record the fact that special playback is performed and on which sections it is done as history logs instead of as section information. In other words, it is possible to obtain history logs on only the part of the contents actually viewed by a user and perform an accurate rating research.

Also, a server apparatus, a terminal apparatus, a history log collecting method and a program for collecting history logs of the present invention that achieves the above-mentioned object have the same structure and effect mentioned above.

With the present invention, as a terminal apparatus records time information securely set for contents as history logs and a user specifies a section of contents which is used by a user by using this time information, a content provider, a service provider or the like can securely obtain important information such as a rating per minute and an average rating

Especially, time information such as the MPEG-2 Systems are included in the content format, and it is possible to construct a content history log collecting system with a high affinity with existing systems in the case where it is difficult to flexibly change the time information when using it.

Further, in the case where contents is not played back or decoded properly or a special playback such as forwarding or rewinding is performed, it becomes possible to obtain history logs of accurately the part of the contents that has been actually used by a user and conduct a rating search more accurately.

Further Information About Technical Background to This Application

Japan Patent application No. 2003-052761 filed, on Feb. 28, 2003 is incorporated herein by reference.

### BRIEF DESCRIPTION OF THE DRAWINGS

These and other subjects, advantages and features of the invention will become apparent from the following description thereof taken in conjunction with the accompanying drawings that illustrate a specific embodiment of the invention. In the Drawings:

FIG. 1 is a diagram showing the outline structure of the whole content history log collecting system 1 concerning the embodiment of the present invention.

FIG. 2 is a functional block diagram showing the structure of the right management server 101b concerning the first embodiment of the present invention.

FIG. 3 is a diagram showing the table structure of the user information DB 201 concerning the first embodiment of the present invention.

FIG. 4 is a diagram showing the table structure of the content key DB 202 concerning the first embodiment of the present invention.

FIG. 5 is a diagram showing the table structure of the use condition DB 203 concerning the first embodiment of the present invention.

FIG. 6 is a diagram showing the table structure of the history log collection condition DB 204 concerning the first embodiment of the present invention.

FIG. 7 is a diagram showing the structure of the LT 700 concerning the first embodiment of the present invention.

FIG. 8 is a diagram showing the structure of the tag block for indicating history log collection 704 concerning the first embodiment of the present invention.

FIG. 9 is a functional block diagram showing the structure of the content distribution server 101c concerning the first embodiment of the present invention.

FIG. 10 is a diagram showing the outline structure of the PES packet 1000 concerning the first embodiment of the present invention.

FIG. 11 is a diagram showing the outline structure of the TS packet 1100 concerning the first embodiment of the present invention.

FIG. 12 is a functional block diagram showing the structure of the history log collecting server 101e concerning the first embodiment of the present invention.

FIG. 13 is a diagram showing the relation between the first time information and the second time information concerning the first embodiment of the present invention.

FIG. 14 is a diagram showing the table structure of the history log DB 1204 concerning the first embodiment of the present invention.

FIG. 15 is a diagram showing the structure of the terminal apparatus 102 concerning the first embodiment of the present invention.

FIG. 16 is a diagram showing the structure of the ELI 1600 concerning the first embodiment of the present invention.

FIG. 17 is a diagram showing the structure of the UL 1700 concerning the first embodiment of the present invention.

FIG. 18 is a flow chart showing the processing for obtaining LT 700 from the right management server 101b in the terminal apparatus 102 concerning the first embodiment of the present invention.

FIG. 19 is a flow chart showing the processing of judging LT issuability in the right management server 101b concerning the first embodiment of the present invention.

FIG. 20 is a flow chart showing the processing for generating a history log collecting indication in the right management server 101b concerning the first embodiment of the present invention.

FIG. 21 is a flow chart showing the processing for using contents and recording history logs in the terminal apparatus 102 concerning the first embodiment of the present invention.

FIG. 22 is a flow chart showing the processing for using contents in the terminal apparatus 102 concerning the first embodiment of the present invention.

FIG. 23 is a flow chart showing the processing for recording history logs in the terminal apparatus 102 concerning the first embodiment of the present invention.

FIG. 24 is a flow chart showing the processing for sending contents in the content distribution server 101c concerning the first embodiment of the present invention.

FIG. 25 is a flow chart showing the processing for sending history logs to the history log collecting server 101e in the terminal apparatus 102 concerning the first embodiment of the present invention.

FIG. 26 is a functional block diagram showing the structure of the content distribution server 101c concerning the second embodiment of the present invention.

FIG. 27 is a functional block diagram showing the structure of the history log collecting server 101e concerning the second embodiment of the present invention.

FIG. 28 is a diagram showing the structure of the terminal apparatus 102 concerning the second embodiment of the present invention.

FIG. 29 is a flow chart showing the processing for using contents in the terminal apparatus 102 concerning the second embodiment of the present invention.

FIG. 30 is a flow chart showing the processing for recording history logs in the terminal apparatus 102 concerning the second embodiment of the present invention.

FIG. 31 is a flow chart showing the processing for sending contents in the content distribution server 101c concerning the second embodiment of the present invention.

### DESCRIPTION OF THE PREFERRED EMBODIMENT(S)

(First Embodiment)

The first embodiment of the present invention will be explained in detail below with reference to figures.

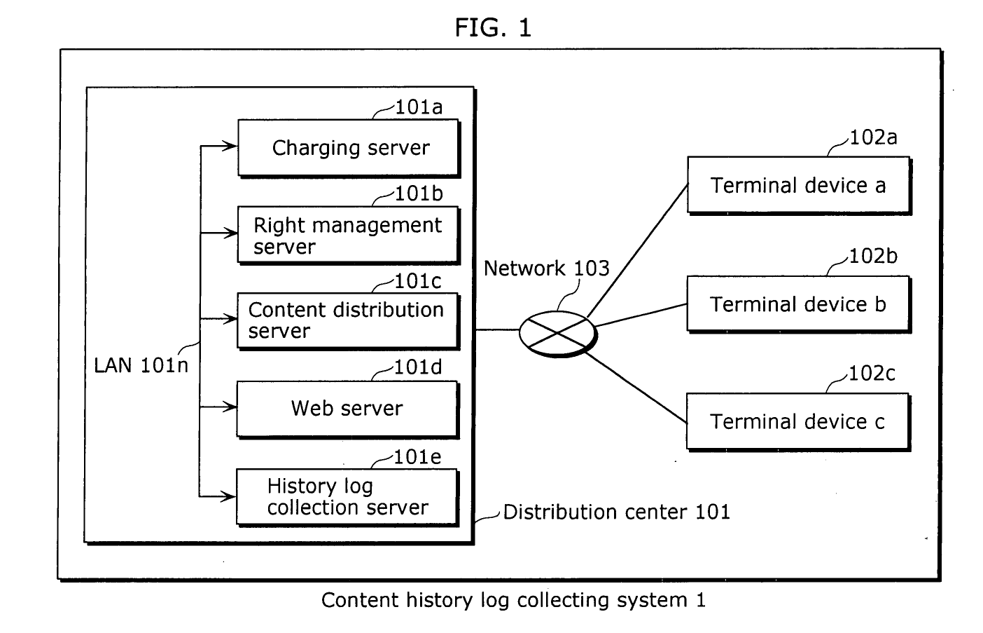

FIG. 1 is a diagram showing the outline structure of the whole content history log collecting system 1 concerning the first embodiment of the present invention.

This content history log collecting system 1 is a system for allowing a user to use encrypted contents to be distributed from a distribution center (that is, a service provider) via a network, a storage media or the like, and to collect the history logs and it comprises a distribution center 101 for distributing contents and the like, terminal apparatuses 102a to 102c for using the contents, a network 103 for connecting them with each other.

The distribution center 101 comprises a charging server 101a for charging a user, a right management server 101b for managing a content use right (use condition) owned by a user, generating a content license and distributing contents to the terminal apparatuses 102a to 102c, a content distribution server 101c for distributing contents, a web server 101d for sending web pages for providing a various kind of services to the terminal apparatuses 102a to 102c via the network 103 and the history log collecting server 101e for managing history logs collected from the terminal apparatuses 102a to 102c.

The charging server 101a is a server apparatus for charging a user on-line when the user purchases content use conditions and the like via the Internet or the like. More specifically, the charging server 101a charges a fee to a credit card or accepts payments by credit card or registers user's bank account number in advance in the charging server 101a and charges a fee to the bank account or accepts payments by bank transfer based on the purchase history and the like uploaded from the terminal apparatuses 102a to 102c via the network 103.

The right management server 101b is a server apparatus for managing a content use condition owned by a user and giving the user the license for decrypting the encrypted contents. More specifically, the right management server 101b manages the content use conditions owned by each user or each of terminal apparatuses 102a to 102c and distributes these licenses to terminal apparatuses 102a to 102c via the network 103 based on a request from a user. Also, in a push-style distribution form such as digital broadcasting, broadband broadcasting or the like, it is possible to use contents by distributing a temporally invalidated license together with the contents and validating licenses by performing charging processing in the terminal apparatuses 102a to 102c.

Note that a generally-used encryption algorithm for encrypting contents is a common key encryption algorithm such as the Advanced Encryption Standard (AES), the Data Encryption Standard (DES) and the like.

Also, a license is data called a license ticket (written as LT below) and comprises a decryption key (a content key) for decrypting encrypted contents, use conditions such as a validated period for using contents, content use times. The data structure of an LT will be explained in detail later with reference to a figure.

In the case where sending and receiving data such as an LT between the distribution center 101 and terminal apparatuses 102a to 102c via the network 103, a Secure Authenticated Channel (written as SAC from here) such as a Secure Socket Layer (SSL) is established so as to ensure security and then the data is received and sent via the SAC.

Also, the content distribution server 101c is a server apparatus for distributing contents to the terminal apparatuses 102a to 102c via the network 103, and it is realized in a form of workstation or the like. More specifically, the content distribution server 101c is digitally compressed using a compression method such as the MPEG-2, MPEG-4 or the like and conducts streaming distribution of the contents encrypted using AES, Triple DES or the like as necessary.

Especially, in the case where streaming distribution of contents is conducted in a network in which the Internet Protocol (IP) such as the Internet is used, the Real Time Transfer Protocol (RTP) and the Real Time Control Protocol (RTCP) are used, both of which are standardized as the Request For Comments (RFC) by the Internet Engineering Task Force (IETF).

The RTP divides contents into packets with a variable length called the RTP packet and transmits them, and information on a reassignment of the RTP packet, a sequence number for detecting a loss of the RTP packet, a time stamp used for synchronizing the video with sound in a stream can be set in the header of the RTP packet. The contents set in the RTP packet can be the ES of the MPEG-2 or the MPEG-4 or multiplexed contents in the MPEG2-Transport Stream (TS). Also, the RTP is generally used considering the User Datagram Protocol (UDP)/IP as the lower protocol.

The RTCP is a protocol for controlling the RTP, used together with the RTP, and can feedback, to the transmission side, a packet loss or a delay jitter which can be detected when receiving the RTP packet. The transmission side performs streaming band width control or the like using this feedback information.

In other words, in a streaming distribution, the content distribution server 101c divides contents requested from the terminal apparatuses 102a to 102c, adds an RTP header to it, generates RTP packets and sends them to the terminal apparatuses 102a to 102c in sequence. The terminal apparatuses 102a to 102c deconstruct the received RTP packet, decode video and sound referring to the information inside the RTP header and output it on a monitor or the like. At that time, it detects a packet loss, a delay jitter or the like which are obtained from the RTP header and sends it to the content distribution server 101c using RTCP.

Also, the content distribution server 101c can be a system for distributing download type contents, in this case, it can be a server apparatus that provides download contents using a protocol such as the File Transfer Protocol (FTP), the HyperText Transfer Protocol (HTTP) and the like. Also, in the case of digital broadcasting, it can be a transmitting device that provides stream type contents in the MPEG-2 Transport Stream (TS) or a transmitting device that provides storage type contents based on a data carousel transmitting method shown in the Association of Radio Industries and Businesses (ARIB) STD-B24 or the like.

The web server 101d provides a user with a screen display for purchasing contents or the like so as to access various kinds of services from the terminal apparatuses 102a to 102c. More specially, the web server 101d provides a web page written in script language such as the HyperText Markup Language (HTML) or the Extensible Markup Language (XML) using a protocol such as HTTP and the like via the Internet or provides a web page written in the Broadcasting Markup Language (BML) in digital broadcasting.

The history log management server 101e is a server apparatus for collecting and managing various kinds of history logs recorded in the terminal apparatuses 102a to 102c. More specifically, the history log collecting server 101e establishes the SAC using the terminal apparatuses 102a to 102c and the SSL or the like and collects content history logs from the terminal apparatus 102a to 102c using a protocol such as HTTP. These pieces of information are managed using a database or the like and utilized as rating data such as a rating per minute, an average rating and the like.

The LAN 101n is a network for connecting a charging server 101a, a right management server 101b, a content distribution server 101c, a web server 101d and a history log collecting server 101e with each other in the distribution center 101. For example, it can be realized using a wired network such as the IEEE 802.3 or the like or a wireless network such as the IEEE 802.11b or the like.

The network 103 is a network that alternately connects the distribution center 101 with terminal apparatuses 102a to 102c. For example, the network 103 is a network of a communication network such as the Internet, digital broadcasting or a multiplexed network of those listed earlier.

The terminal apparatuses 102a to 102c have a function for connecting with the network 103 and are terminal apparatuses for enabling a user to use contents on a monitor display screen or write contents on a storage medium. More specifically, the terminal apparatuses 102a to 102c are any of a Set Top Box (STB) for receiving digital broadcasting, a digital TV, a Digital Versatile Disc (DVD) recorder, a Hard Disk Drive (HDD) recorder, a content displaying device such as a Personal Computer (PC), a recorder or a multiplexed device of those listed earlier.

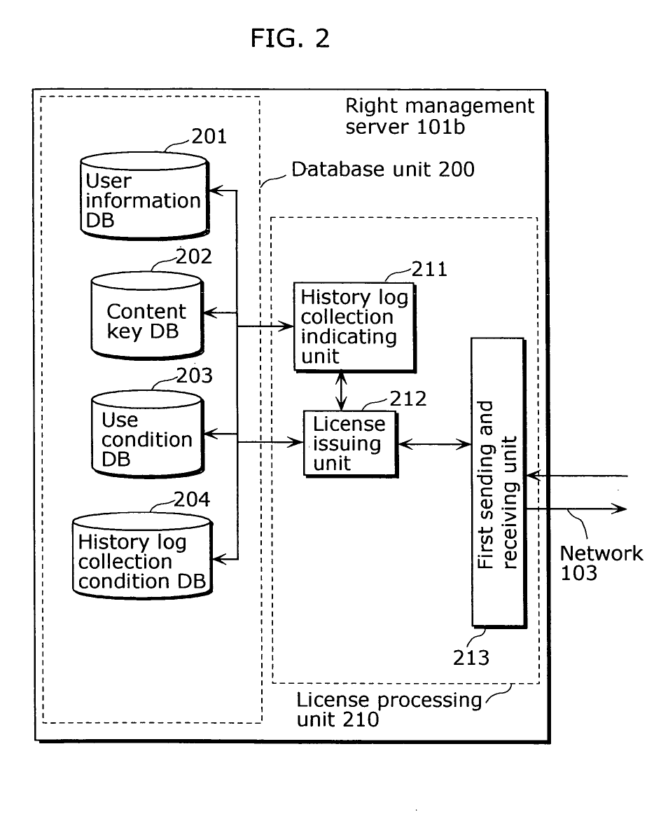

Processing for distributing contents or a license via the network 103, using the contents in the terminal devices 102 to 102, recording content history logs, and sending the history logs from the terminal devices 102a, 102b and 102c to the distribution center 101 in this content history log collecting system 1 will be explained FIG. 2 to 25. As to terminal devices 102a to 102c, terminal device 102a is the representative and explained as the terminal device 102 below. Also, here is shown an example where the right management server 101b of the distribution center 101 instructs the terminal device 102 to collect history logs using an LT.

FIG. 2 is a functional block diagram showing the detailed structure of the right management server 101b in the distribution center 101 shown in FIG. 1.

The right management server 101b comprises, roughly in part, a database unit 200 that is realized by a data file or the like stored in an HDD or the like and a license processing unit 210 that is realized by a hardware such as an LSI or a program or the like that is executed using a CPU, RAM, ROM or the like. The database unit 200 comprises a user information DB 201, a content key DB 202, a use condition DB 203, a history log collection condition DB 204 and the license processing unit 210 comprises a history log collection indication unit 211, a license issuing unit 212, the first history log sending and receiving unit 213.

First, each component of the database 200 will be explained in detail.

The user information DB 201 is a database that has a user information management table for managing the information on a user and is used for associating the terminal apparatus 102 for accessing the right management server 101b with a user who owns a content use condition that is managed in the use condition DB 203.

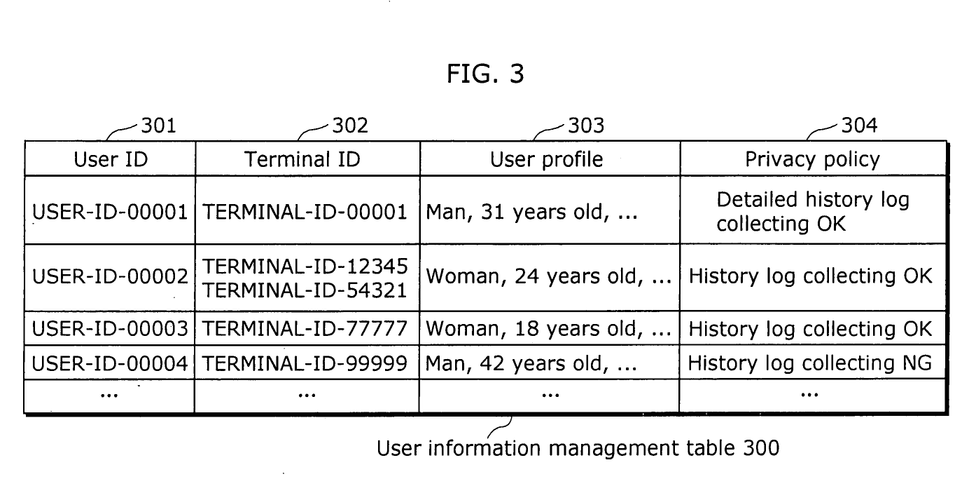

More specifically, the user information DB 201 has the user information management table 300 shown in FIG. 3 and manages a user ID 301 for identifying a user in the content history log collecting system 1, a terminal ID 302 for identifying the terminal apparatus 102 in the content history log collecting system 1, a user profile 303 for showing the detailed information on a user and a privacy policy 304 for showing each user's policy on history log collection.

Here, the user profile 303 shows registered user information such as user's name, age, sex, address, favorite programs, hobbies and so on and can be used for choosing users whose history logs are to be collected and can also be used as a judgmental standard for analyzing user's content use tendency based on the relationship between user's favorite program and a program collected as history logs.

Also, the privacy policy 304 is information showing whether a user permits a service provider to use part or all of his or her content history logs or not and is for realizing history logs according to each user's intention on privacy.

For example, in FIG. 3, it is shown that a user whose user ID 301 is “USER-ID-00001” owns a terminal apparatus 102 whose terminal ID 302 is “TERMINAL-ID-00001”. Also, a user profile 303 shows that a user whose user ID is “USER-ID-00001” is a man of 31 years old, and that he permits his service provider to collect his content history logs in the terminal apparatus 102 in detail because his privacy policy 304 reads “history log collecting OK”. Here, history logs mean detailed user operation descriptions and the like concerning the contents used by the user in the terminal apparatus 102, these history logs are information concerning the played back part of the contents, special playback such as forwarding and rewinding and the like.

Also, a user whose user ID 301 is “USER-ID-00002” owns two terminal apparatuses 102 whose terminal IDs 302 are “TERMINAL-ID-12345” and “TERMINAL-ID-54321” respectively, which shows that she can access the right management server 101b from any of terminal apparatuses 102.

Also, the privacy policy 304 of a user whose user ID is USER-ID-00002” reads “History log collecting OK”, which shows that she permits her service provider to collect her history logs in the terminal 102. In contrast, the privacy policy 304 of a user whose user ID is USER-ID-00004” reads “History log collecting NG”, which shows that he does not permit his service provider to collect content history logs.

Note that data is registered to the user information DB 201 when a service provider registers a user as a member to provide him or her with services. A user can perform this member registration processing on-line between the distribution center 101 and the terminal apparatus 102 using a member registration display screen which is provided by a web server 101d via the network 103 or off-line using a postcard for member registration or the like. In the member registration processing, a service provider assigns a user a user ID 301 first. After that, as a terminal ID 302 of a user terminal apparatus 102 is sent to the service provider on-line or off-line, the user ID 301 is associated with the terminal apparatus ID 302 and these IDs are registered in the user information management table 300 of the user information DB 201. As a result from performing the member registration processing like shown above, user information DB 201 is established.

The content key DB 202 is a database unit operable to manage content keys for decoding encrypted contents, is used for obtaining a content key corresponding to a content ID included in an LT obtainment request when generating an LT as a response to a license obtainment request (an LT obtainment request) from the terminal apparatus 102.

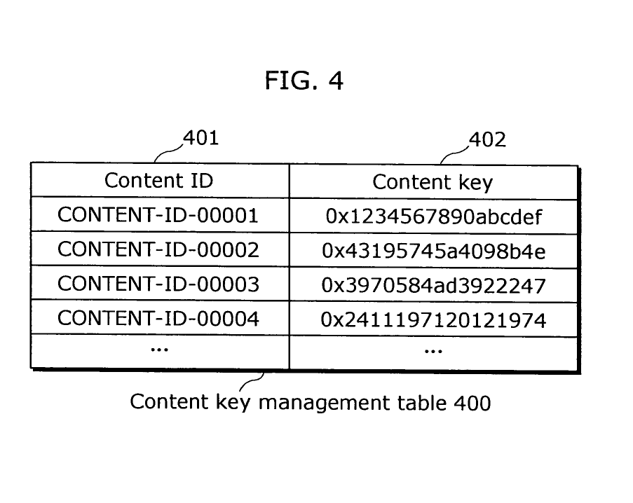

More specifically, the content key DB 202 owns a content key management table 400 comprising a content ID 401 for identifying contents in the content history log collecting system 1 and a content key 402 corresponding to the content ID 401 as shown in FIG. 4.

For example, the content key 402 needed for decrypting the encrypted contents whose content ID 401 is “CONTENT-ID-00001” is the one whose content key ID 402 is “0x1234567890abcdef”.

The use condition DB 203 is a database unit operable to manage content use conditions for each user and is used for generating an LT when it judges that the LT obtainment request from the terminal apparatus 102 satisfies user's use condition.

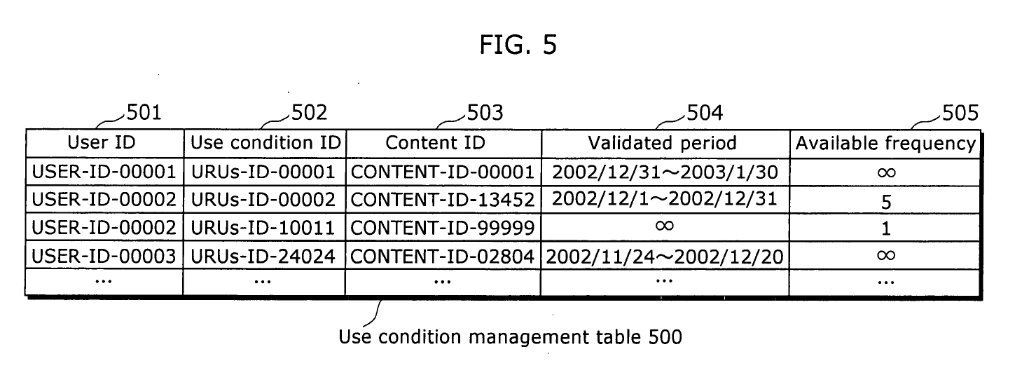

More specifically, the use condition DB 203 identifies a user in the content history log collecting system 1 as shown in FIG. 5 and owns a use condition management table 500 comprising a user ID 501 showing the owner of the use condition, a use condition ID 502 for identifying a use condition owned by a user shown by the user ID 501, a content ID 503 for identifying contents to be made available by a use condition in the content history log collecting system 1, a validated period 504 showing starting and finishing date and time for using the contents shown by the content ID 503 and an available times 505 showing content available times shown by the content ID 503.

For example, a user whose user ID 501 is “USER-ID-00001” holds a use condition of “URUs-ID-00001” as a use condition ID 502. The use condition “URUs-ID-00001” is contents of “CONTENT-ID-00001” shown by the content ID 503 as contents to be made available, the validated period 504 is “2002 Dec. 31 to 2003 Jan. 30” and the available times 505 is infinite, that is, it can be used unlimitedly. Also, a user whose user ID 501 is “USER-ID-00002” owns two use conditions of “URUs-ID-00002” and “URUs-ID-10011” as the use condition ID 502. The use condition “URUs-ID-00002” out of these two is a use condition corresponding to the contents whose content ID 503 is “CONTENT-ID-13452”, the validated period 504 is “2002 Dec. 1 to 2002 Dec. 31”, the available times 505 is “5 times”, which shows that the contents is available up to 5 times during the validated period. Also, the use condition “URUs-ID-10011” is a content use condition of “CONTENT-ID-99999” as the content ID 503, the validated period 504 is infinite but the content available times is only “1 time” as shown by the available times 505.

The history log collection condition DB 204 is a database operable to manage conditions for indicating the collection of the history log to the terminal apparatus 102 and is used for managing data such as conditions concerning which users' history logs should be collected, timing for recording the history logs in the terminal apparatus 102, timing for sending the history logs from the terminal apparatus 102 to the history log collecting server 101e, descriptions of the history logs to be recorded and the like specific for each contents and is used when instructing the terminal 102 to collect the history log.

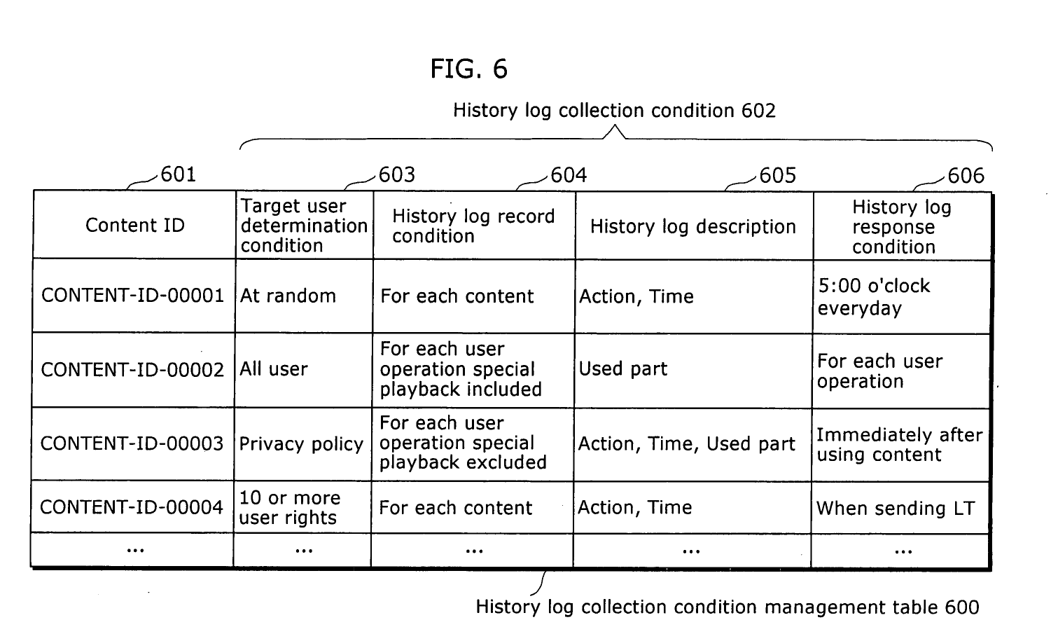

More specifically, the history log collection condition DB 204 has a history log collection condition management table 600 comprising a content ID 601 for identifying contents in the content history log collecting system 1 and a history log collection condition 602 showing conditions for determining users whose history logs are to be collected and conditions on timings for collecting the history logs and descriptions of the history logs as shown in FIG. 6. The history log collection condition 602 includes a target user determination condition 603 showing conditions for determining users whose history logs are to be collected, a history log record condition 604 showing conditions for recording the history logs, a history log description 605 showing articles (descriptions) of the history logs to be recorded and a history log response condition 606 showing conditions for sending the recorded history logs from the terminal apparatus 102 to the history log collecting server 101e.

For example, as to the contents whose content ID 601 is “CONTENT-ID-00001”, users whose history logs are to be collected or terminal apparatuses 102 are determined “at random” as shown by the target user determination condition 603. Also, the settings of the history log record condition 604 are “for each contents”. This means that a user obtains history logs for each contents used by a user for example, it is the case where history logs are recorded at the time of starting using contents. As the settings of the history log description 605 are “action, time”, descriptions of user operation (action) such as playback or copy of contents or the like and the time when the user performed these operations. Further, the setting of the history log response condition 606 is “5:00 o'clock everyday”, which indicates that the registered history logs are sent to the history log collecting server 101e at 5:00 o'clock everyday. As mentioned up to this point, the setting of the history log collection condition 602 of the contents “CONTENT-ID-00001” are as follows: target users whose history logs are to be collected are determined “at random” from the user information DB 201, orders the determined user to record “action” and “time” when the action is executed “for each contents” and the recorded history logs are sent to the history log collecting server 101e at “5:00 o'clock everyday”. Here, a conceivable method for determining users whose history logs are to be collected at random is, for example, a method of generating random numbers using random numbers or the like and choosing users corresponding to user IDs 301 (such as 5-digit numbers following “USER-ID-”) in the user information management table 300 of the user information DB 201 corresponding to these random numbers.

Also, as the target user determination condition 603 of the contents whose content ID 601 is “CONTENT-ID-00002” reads “all users”, all users whose LT of contents “CONTENT-ID-00002” is determined as a target user whose history logs are to be collected. Also, as shown by the history log record condition 604 of the “CONTENT-ID-00002” which reads “for each user operation, special playback included”, it is instructed to record history logs for each user operation, in other words, each time a user performs a user operation (such as playback, stop, pause, forward or the like). Also, as shown by the history log description 605 of the “CONTENT-ID-00002” which reads “used part”, the history log record condition 604 instructs to record the history log record condition including special playback part in detail as to which part of the contents is used by a user. Also, as shown by the history log response condition 606 of the “CONTENT-ID-00002” which reads “for each user operation”, the history logs are sent from the terminal apparatus 102 to the history log collecting server 101e when one or plural number of user operations are performed.

Further, in the case of contents whose content ID 601 is “CONTENT-ID-00003”, as its target user determination condition 603 reads “privacy policy”, whether the user makes a target user whose history logs are to be collected or not is judged according to the user privacy policy by referring to the user information DB 201. The history log collection condition 604 of this content “CONTENT-ID-00003” instructs to collect history logs under the condition of “for each user operation, special playback excluded” and to record history logs for each user operation, in other words, for each user operation, excluding history logs on special playback such as forwarding and rewinding. Also the history log description 605 records descriptions of user operations, the time when a user performed the operation (absolute time) indicated as “action, time, used part” and instructs to collect which part of the contents is viewed by a user in detail excluding special playback part.

Note that the history log response condition 606 of the contents whose content ID 601 is “CONTENT-ID-00003” reads “immediately after using contents” and thus it is an example indicating a request that the history logs should be sent from the terminal apparatus 102 to the history log collecting server 101e when finishing using the contents.

Also, in the case of contents whose content ID is “CONTENT-ID-00004”, its target user determination condition 603 reads “10 or more user rights” indicating that only history logs of users who have 10 or more records of use conditions should be collected in the use condition DB 203. Also, as the history log response condition 606 specifies as “when sending LT” so as to collect history logs synchronizing with the timing for returning “1” or a plurality of LTs.

Up to this point, each unit of the database unit 200 has been explained in detail.

Next, each unit of the license processing unit 210 will be explained in detail.

The history log collection indication unit 211 generates indication information for indicating the history log collection to the terminal apparatus 102.

More specifically, the history log collection indication unit 211 generates indication information for the history log collection using a user information DB 201, a use condition DB 203, a history log collection condition DB 204 and the like as necessary when receiving an LT issuing request from a user and sends the indication information to a license issuing unit 212 so as to make it an LT.

The license issuing unit 212 generates an LT in response to the LT issuing request from the terminal apparatus 102.

More specifically, the license issuing unit 212 uses the user information DB 201, the content key DB 202 and the use condition DB 203 in response to the LT issuing request from the terminal apparatus 102 and performs processing for generating an LT on condition that the LT issuing request satisfies the user use condition or not. Also, the license issuing unit 212 receives indication information for the history log collection from the history log collection indication unit 211 so as to indicate that users' history logs of contents should be collected from the right management server 101b to the terminal apparatus 102 and sets the indication information as the LT.

The first sending and receiving unit 213 communicates with the terminal apparatus 102 via the network 103.

Up to this point, detailed structure of the right management server 101b has been explained.

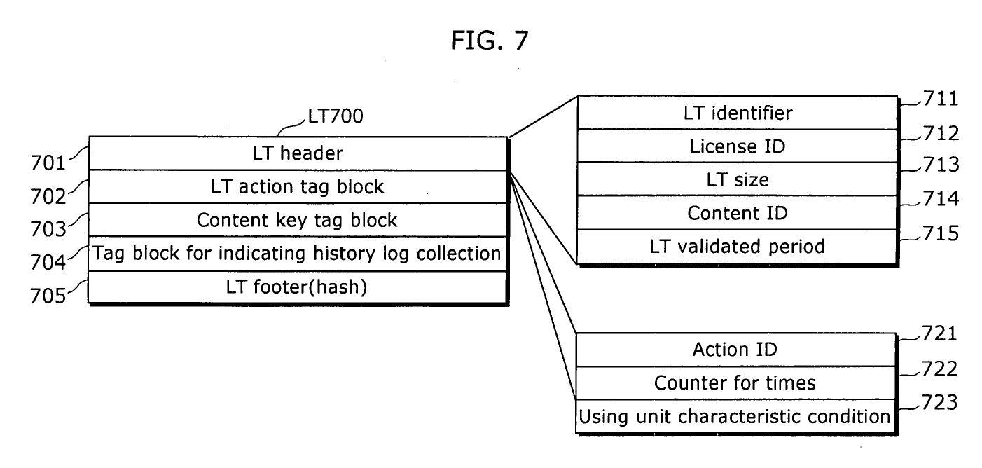

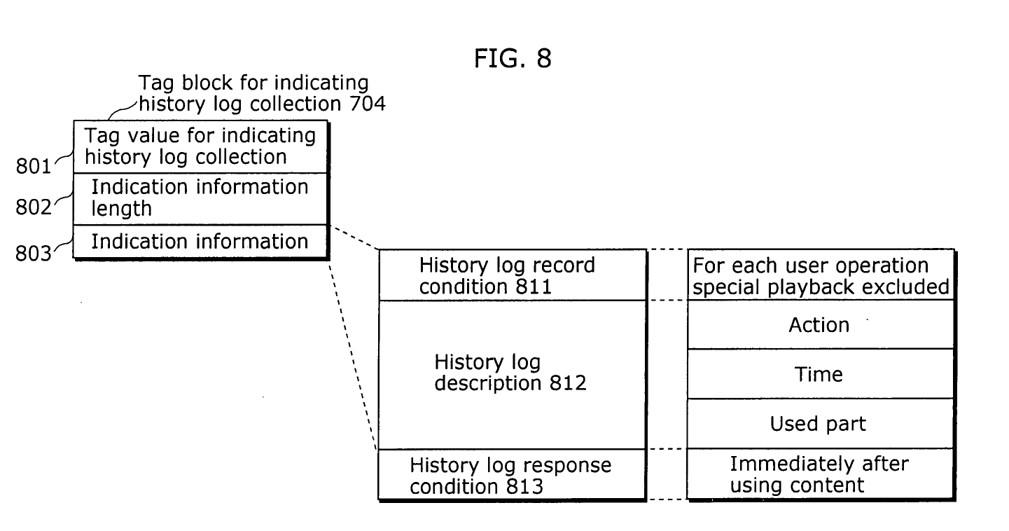

Here, the structure of the indication information for collecting LTs to be issued by the license issuing unit 212 and the history logs to be generated by the history log collection indication unit 211 will be explained in detail with reference to FIGS. 7 and 8.

FIG. 7 is a diagram showing an example of an LT structure. The LT 700 shown in FIG. 7 comprises a content ID of the contents to be made available by the LT 700, an LT header 701 including the validated period of the LT 700 and the like, an LT action tag block 702 showing use conditions such as available times of playing back contents and copying contents on a storage medium, a content key tag block 703 including a content key for decrypting a content, a tag block for indicating history log collection 704 for indicating the history log collection from the right management server 101b to the terminal apparatus 102, an LT footer 705 as a hash value for detecting manipulation of the LT 700.

The LT header 701 comprises an LT identifier 711 for identifying the LT 700, an LT size 713 showing the length of the whole LT 700, a content ID 714 as an identifier of the contents to be made available by the LT 700 and an LT validated period 715 showing the validated period of the LT 700.

The LT action tag block 702 comprises an action ID 721 for identifying a user action corresponding to the contents such as “playback”, “copy”, “print” or the like, a counter for times 722 showing the available times of action execution and a using unit characteristic condition 723 showing characteristic (proprietary) use conditions of the content using unit 251 that plays back contents, copies them or the like. Here, the using unit characteristic condition 723 is use conditions depending on the type or performance of the unit for using the contents in the terminal apparatus 102. For example, sound channel indication of movie contents (it can be played back on 5.1 ch or 2 ch) or the resolution of the image contents, the size indication and the like.

A content key for decrypting the encrypted contents is set using a binary value in the content key tag block 703.

The tag block for indicating history log collection 704 is a tag block to be generated in the history log collection indication unit 211 and has a format shown in FIG. 8.

Here, the detailed structure of the tag block for indicating history log collection 804 will be explained with reference to FIG. 8.

The tag block for indicating history log collection 704 comprises a tag value for indicating history log collection 801 that is an identifier for identifying the tag block for indicating history log collection 704, an indication information length 802 showing the length of the tag block for indicating history log collection 704 and an indication information 803 of information indicating collecting the history logs.

The indication information 803 comprises a history log record condition 811, a history log description 812 and a history log response condition 813. Here, as the history log record condition 811, “for each user operation, special playback excluded” shows the instruction to record history logs for each user operation for using contents excluding special playback, “action”, “time” and “used part” of the history log description 812 shows the instruction to record an action indicating a user operation description (such as playback, copy or the like) by a user and the absolute time when the action was performed, and “immediately after using contents” of the history log response condition 813 shows the instruction to send history logs to the history log collecting server 101e immediately after finishing the content use.

Note that it is possible to equip a secure timer unit, in the terminal apparatus 102, for recording the absolute time when the contents was used in preparation to the case where “time” is specified in the history log description 812.

Up to this point, the detailed structure of the tag block for indicating history log collection 804 has been explained with reference to FIG. 8. The LT 700 will be explained below with reference to FIG. 7.

The LT footer 705 detects a manipulation and ensures the authenticity of the LT 700 when storing an LT 700 in a non-secure part in a hard disk or the like, and it calculates the hash value of the LT 700 and manages the calculation result (the hash value) each time the contents of the LT is updated. This hash value needs to be managed in the tamper-proofed part at hardware level. As to a specific hash algorithm, Secure Hash Algorithm (SHA-1), SHA-256 or the like is used.

Up to this point, the detailed structures of the LT 700 and the tag block for indicating history log collection 704 as indication information for collecting the history logs have been explained with reference to FIGS. 7 and 8, which is the end of the detailed explanation on each unit of the license processing unit 210.

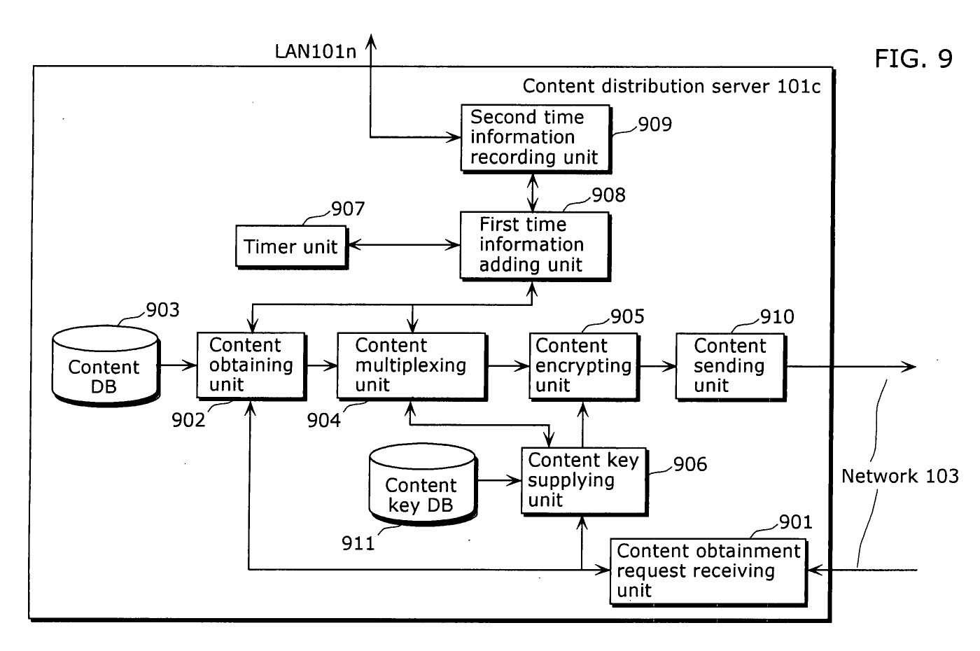

Next, FIG. 9 is a functional block diagram showing the detailed structure of the content distribution server 101c in the distribution center 101 shown in FIG. 1.

The content distribution server 101c is an apparatus for outputting the contents such as the MPEG-2, MPEG-4 or the like in the MPEG-2 TS in response to the content obtaining request from the terminal apparatus 102 and comprises a content obtainment request receiving unit 901, a content obtaining unit 902, a content DB 903, a content multiplexing unit 904, a content encrypting unit 905, a content key supplying unit 906, a timer unit 907, a first time information adding unit 908, a second time information recording unit 909, a content sending unit 910 and a content key DB 911.

The content obtainment request receiving unit 901 receives content sending request from the terminal apparatus 102 and the content stop request and send them to the content obtaining unit 902. More specifically, the content obtainment request receiving unit 901 receives a play indication (PLAY) in Realtime Transport Streaming Protocol (RTSP), sends an obtainment indication of the content to the content obtaining unit 902 and then starts sending contents from the content distribution server 101c. Also, in the case where it receives content stop request (TEARDOWN) in RTSP from the terminal apparatus 102, it stops sending contents from the content distribution server 101c by sending the obtainment indication of the contents to the content obtaining unit 902. Further, it is possible to process a request for special playback such as PAUSE in RTSP or the like.

The content obtaining unit 902 reads out the contents requested from the terminal apparatus 102 from the content DB 903 and sends it to the terminal apparatus 102.

More specifically, the content obtaining unit 902 is a real time encoder for generating MPEG streams and is operable to read out video, sound or the like from the content DB 903 according to an instruction from the content obtainment request receiving unit 901 and generate the ES of video, sound, data or the like using the MPEG-2 or the MPEG-4. Further, it generates Packetized Elementary Stream (PES) packets including these ESs and send them to the content multiplexing unit 904.

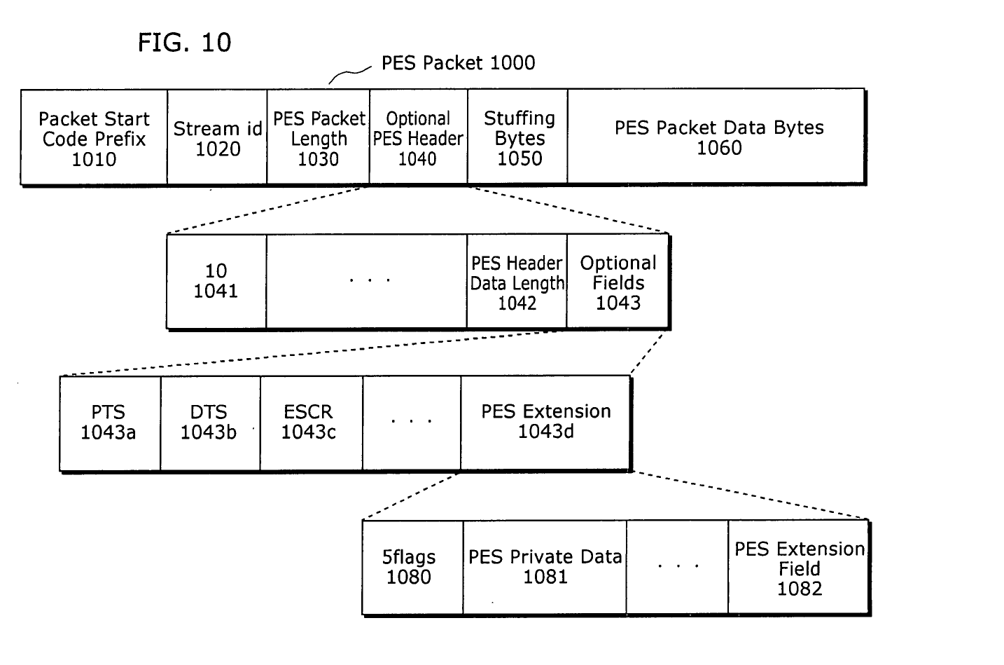

Here, the outline of the structure of the PES packet will be explained with reference to FIG. 10. The PES packet 1000 shown in FIG. 10 comprises a Packet Start Code Prefix 1000 of a code that shows the start of the PES packet, a Stream id 1020 that shows data type of sound, video or the like included in the PES, a PES Packet Length 1030 that shows the length of the PES packet 1000, an Optional PES Header 1040 that is a PES header of an option, a Stuffing Bytes 1050 of a stuffing and a PES Packet Data Bytes 1060 where data (ES) sound, video or the like are set.

Explanation on the structure of the content distribution server 101c is going on below with reference to FIG. 9 again.

The content DB 903 is a database unit operable to store contents. More specifically, the content DB 903 is a Video Cassette Recorder (VCR) for storing, for example, movies, documentaries or the like, or a video camera for videotaping movies and sound at the time of live broadcasting.

The content multiplexing unit 904 multiplexes contents such as video, sound, data or the like received from the content obtaining unit 902 and sends them to the content encrypting unit 905. More specifically, the content multiplexing unit 904 multiplexes the PES contents into the MPEG-2 TS packet (written as TS packet from here) and generates a transport stream.

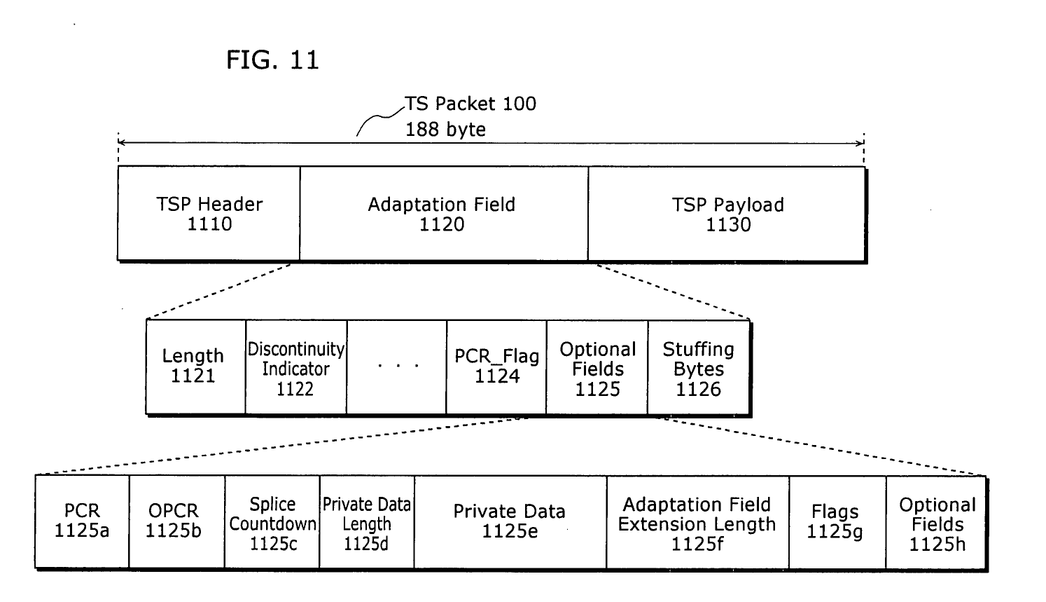

FIG. 11 is a diagram showing the outline of the TS packet structure. The TS packet 1100 is used optionally together with a code showing the start of the TS packet 1100 and the TSP Header 1110 that is a header of the TS packet 1100 including the Packet ID (PID) for identifying data type to be set in the TS packet or the like and comprises an Adaptation Field 1120 capable of setting time information, private data and the like and a TSP Payload 1130 that is a payload where Program Specific Information (PSI)/Service Information (SI) or the like is set.

The content multiplexing unit 904 sends the transport stream (TS packet 1100) generated in this way to the content encrypting unit 905.

The content encrypting unit 905 encrypts contents using the AES. More specifically, the content encrypting unit 905 encrypts the payload unit (TSP Payload 1130) excluding the Adaptation Field 1120 of the TS packet 1100 shown in FIG. 11 in Cipher Block Chaining (CBC) mode using a content key (encryption key) obtained from the content key supplying unit 906.

The content key supplying unit 906 obtains a content key for encrypting contents from the content key DB 911 and provides content encrypting unit 905 with it.

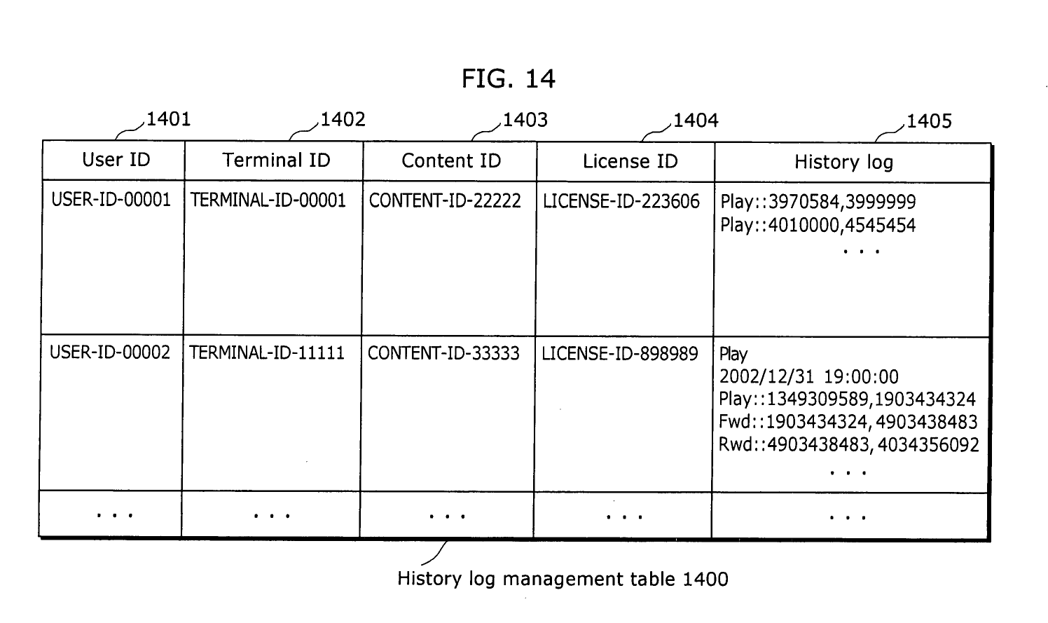

The content key DB 911 is a database unit operable to manage a content key for encrypting contents and provide the content key supplying unit 906 with a content key corresponding to a content ID according to the request from the terminal apparatus 102. Explanation of an example of a table structure managed by the content key DB 911 is omitted here because it can be the same as the content key table 400 of the content key DB 202 in the right management server 101b shown in FIG. 14.

It is needless to say a content key of each content managed in the content key DB 911 and a content key for each content managed in the content key DB 202 in the right management server 101b (that is, a key for decrypting contents set in the LT 700) are managed in a consistent manner.

The timer unit 907 outputs time that is a standard in the content distribution server 101c. More specifically, the timer unit 907 generates the standard time of 42 bits with accuracy of 27 MHz called System Time Clock (STC) and supplies it to the first time information adding unit 908.

The first time information adding unit 908 obtains the STC from the timer unit 907 and adds the first time information to the content obtaining unit 902 and the content multiplexing unit 904. More specifically, the first time information adding unit 908 obtains the value of the STC from the timer unit 907 and assigns, to the content obtaining unit 902, a time stamp for the Presentation Time Stamp (PTS) and the Decoding Time Stamp (DTS) with accuracy of at least 700 ms according to the protocol of the MPEG-2 Systems. Also, it assigns a time stamp for the Program Clock Reference (PCR) to the content multiplexing unit 904 with accuracy of at least 100 ms according to the protocol of the MPEG-2 Systems.

In other words, the content obtaining unit 902 adds, to the PES packet 1000, the PTS 1043a and the DTS 1043b that are components of the Optional Fields 1043 in the Optional PES Header 1040 when generating the PES packet 1000 using the first time information obtained from the first time information adding unit 908, using the value of time stamps for PTS and DTS.

The PTS 1043a is information showing the time when displaying video, sound and the like included in the PES packet 1000 in the terminal apparatus 102a to 102c. Also, the DTS 1043b is information showing the time for decoding video, sound and the like included in the PES packet 1000.

These PTS 1043a and the DTS 1043b are set in an appropriate PES packet 1000 in a way that each of the PES packets are surely decoded and displayed in the terminal apparatus 102a to 102c for corresponding STCs stored in the terminal apparatus 102a to 102c.

Also, when generating the TS packet 1100 using the value of the first time information (a time stamp for PCR) obtained from the first time information adding unit 908, it adds, to the content multiplexing unit 904, the PCR 1125a that is a component in the Optional Fields 1125 of the Adaptation Field 1120 in the TS packet 1100. It becomes possible that the terminal apparatus 102a to 102c reproduce the system clock (STC) that is synchronized with the STC of the sending device for synchronizing a plurality of ESs (video, sound, data and the like) with each other using this PCR 1125a.

The terminal apparatus 102a to 102c become a standard for synchronizing a plurality of ESs (video, sound, data and the like) with each other using this PCR 1125a and make it possible to reproduce the system clock (STC) that is synchronized with the STC of the sending device.

Here, the first time information added to the PCR 1125a is used for recording which part of the contents is used by a user in the terminal apparatus 102, as the PCR 1125a is included in the non-encrypted part of the TS packet 1100, there is a fear that the value of the PCR 1125a is illicitly manipulated and right history logs cannot be obtained in the distribution center 101. Therefore, in the content multiplexing unit 904 calculates hashes of at least the PCR 1125a and the TSP Payload 1130 to be encrypted in the content encrypting unit 905 and sets them in the Private Data 1125e in the TS packet 1100. In other words, the content multiplexing unit 904 securely binds the first time information and the contents.

Note that an appropriate value is set as the Private Data Length 1125d according to the length of the added hash value. A case where hashes of the Adaptation Field 1120 and the TSP Payload 1130 are calculated and set in the Private Data 1125e is considered in this embodiment. The hash calculation method is not limited to this embodiment. The PCR 1125a that is the first time information and any secret information shared at least between the content encrypting unit 905 and the content decrypting unit 1521 of the terminal apparatus 102 may be used for recognizing which part of hashes of the TS packet 1100 is calculated. Also, the first time information is not limited to the above-mentioned PCR 1125a, and it may be, for example, the time information set in the private data unit (Private Data 1125e) or the like.

Also, as the first time information adding unit 908 obtains the value of the PCR 1125a when contents (program) start, for example, on condition that a flag showing the start (head) of the contents is set in the Private Data 1125e of the TS packet 1100 in the content obtaining unit 902, the first time information adding unit 908 can obtain the value of the PCR 1125a (that is, the STC value) at the time of detecting the above-mentioned flag as the second time information and send it to the second time information recording unit 909. Note that it is also possible to receive the timing for starting contents from the upstream system (such as a program scheduling management system or the like) that is not shown in FIG. 9.

The second time information recording unit 909 records the value of the first time information which is in the head of the contents, that is, the second time information obtained from the first time information adding unit 908. This second time information is sent to the history log collecting server 101e so as to record history logs via the LAN 101n as necessary.

The content sending unit 910 sends the TS packet encrypted in the content encrypting unit 905 to the terminal apparatus 102. More specifically, the content sending unit 910 sets the TS packet 1100 received from the content encrypting unit 905 in the RTP packet and sends it to the terminal apparatus 102 via the network 103. Note that a method for using a format written in the RFC 2250 (RTP Payload Format for MPEG-1/MPEG-2 Video) or the like is listed as a method for sending the TS packet 1100 in the RTP packet.

An example where contents stored in the content DB 903 are read out and encoded in real time in the content obtaining unit 902 is shown here, but previously generating the PES (ES) or TS in off-line and storing it in the content DB 903 enables the content obtaining unit 902 to perform only the processing for reading out the PES or the TS from the content DB 903.

Also, an example where the content encrypting unit 905 encrypts the non-encrypted contents stored in the content DB 903 when sending the contents here, it is also possible to store the previously encrypted TS.

Up to this point, the structure of the content distribution server 101c that sends contents from the distribution center 101 to the terminal apparatus 102 has been explained in detail with reference to FIG. 9 to FIG. 11.

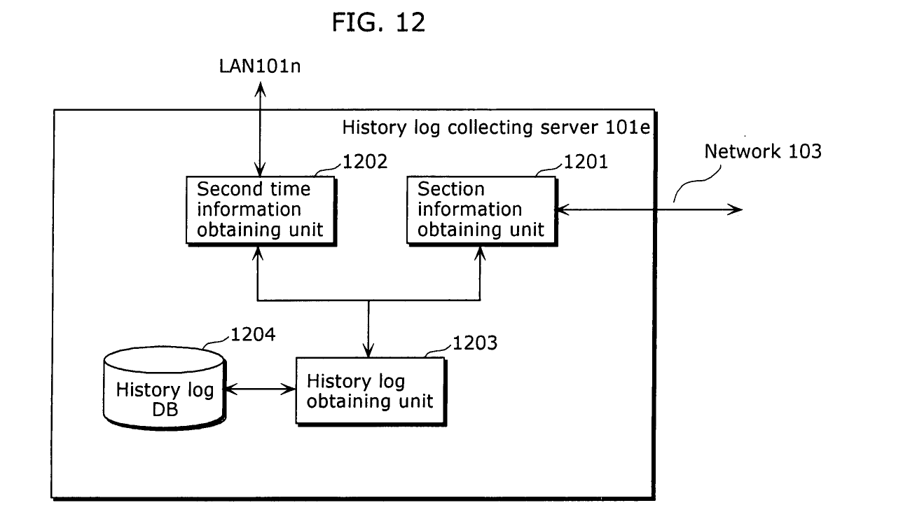

FIG. 12 is a functional block diagram showing the detailed structure of the history log collecting server 101e in the distribution center 101 shown in FIG. 1.

The history log collecting server 101e comprises a section information obtaining unit 1201, the second time information obtaining unit 1202, a history log obtaining unit 1203 and a history log DB 1204.

The section information obtaining unit 1201 obtains the section information from the terminal apparatus 102. Here, the section information shows the section of the contents used in the whole section of the contents and it includes the starting time information showing the value of the first time information at the time of starting using contents and the starting time information showing the value of the first time information at the time of finishing using contents. More specifically, the section information obtaining unit 1201 receives the section information recorded as content history logs in the terminal apparatus 102 via the network 103. As to the communication with the terminal apparatus 102, with an aim to secure the security of the section information, it is possible to receive/sends the section information after establishing the SAC with the Public Key Infrastructure (PKI) from/to the terminal apparatus 102 or communicate after encrypting the section information using the encryption key that can be recognized only by the history log collecting server 101e and the terminal apparatus 102 without performing any mutual authentication.

The second time obtaining unit 1202 obtains the second time information from the content distribution server 101c. More specifically, the second time information obtaining unit 1202 performs processing for obtaining, together with the content ID, the value of the first time information at the time of starting the contents that is stored for each content ID in the second time information recording unit 909 of the content distribution server 101c.

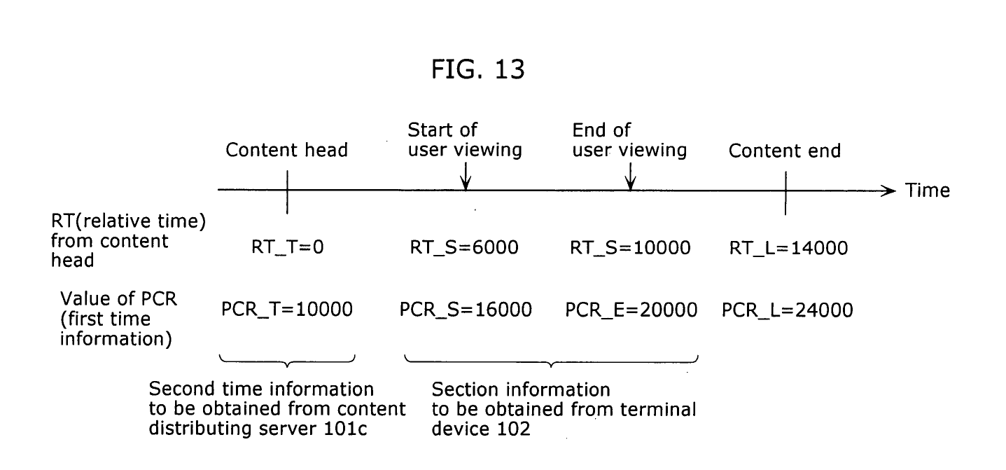

The history log obtaining unit 1203 calculates history logs based on the section information and the second time information. More specifically, the history log obtaining unit 1203 performs processing for obtaining the information on which part of the contents is used by a user as history logs based on the difference between the section information obtained by the section information obtaining unit 1201 and the second time information obtained by the second time information obtaining unit 1202. This processing will be explained in detail with reference to FIG. 13.

FIG. 13 is a figure for explaining the descriptions of the section information obtained by the history log obtaining unit 1203 and the second time information. The horizontal axis (arrow) of FIG. 13 shows how time passes while contents are being sent and shows that time passes from left to right of the arrow. The value of the relative time (RT) from the head of the contents written below this horizontal axis is “0” at the head of the contents (RT_T) and is a monotone increasing value as time passes. Values of the STC that are timed in the timer unit 907 in the content distribution server 101c are set as the PCR 1125a of the TS packet 1100 by the time information adding unit 908 and written as values of the first information (PCR).

Here is an example where certain contents is started to be sent at the timing when the PCR value is 10000 (PCR_T), in other words, it shows the starting point of the contents, and finished to be sent at the timing when the PCR value is 24000 (PCR_E), in other words, it shows the ending point of the contents. Provided that the contents sent in this way is started to be viewed when the PCR value is 16000 (PCR_S) and finished to be viewed when the PCR value is 20000 (PCR_E), the value of the PCR_S and the PCR_E, that is, 16000 and 20000 are recorded as the section information recorded in the terminal apparatus 102.

On the other hand, the second time information recording unit 909 in the content distribution server 101c records 10000 (PCR_T) that is the value of the PCR at the starting timing of sending the contents as the second time information. Therefore, the history log obtaining unit 1203 calculates history logs indicating which part of the contents (the starting and the ending points of using the contents) is used, in other words, the values of 6000 (RT_S) and 10000 (RT_E) that are the relative time from the starting point of the contents using calculation formulas of (RT_S)=(PCR_S−PCR_T) and (RT_E)=(PCR_E−PCR_T).

The history log DB 1204 is a database operable to manage history logs. More specifically, the history log DB 1204 receives history logs obtained from the history log obtaining unit 1203 and records them in the history log management table 1400 shown in FIG. 14. The history log management table 1400 shown in FIG. 14 comprises a user ID 1401, a terminal ID 1402, a content ID 1403, a license ID 1404 and a history log 1405.

The user ID 1401 is an ID for identifying a user in the content history log collecting system 1.

The terminal ID 1402 records an ID for identifying the terminal apparatus 102 in the content history log collecting system 1.

The content ID 1403 is an ID for identifying contents used in the terminal apparatus 102 in the content history log collecting system 1.

The license ID 1404 is an ID for identifying the license (LT 700) that authorizes using the contents specified in the content ID 1403 in the content history log collecting system 1. Note that the license ID 1404 may be unique to the user ID 1401 or the terminal ID 1402 depending on its use.

The history log 1405 shows history logs calculated by the history log obtaining unit 1203 of the history log collecting server 101e.

For example, it is shown that the user “USER-ID-00001” used the contents “CONTENT-ID-22222” in the terminal apparatus 102 “TERMINAL-ID-00001”. Also, it is shown that the license ID 1404 for identifying the LT 700 that authorized using the contents “CONTENT-ID-22222” is the “LICENCE-ID-223606”. The history log 1405 shows the information for identifying which part of the contents “CONTENT-ID-22222” is used by a user “USER-ID-00001”, for example, “Play :: 3970584, 3999999” shows that the contents is played back or viewed between 3970584 and 3999999 of the relative time from the starting part of the contents.

Note that the actual content starting time can be calculated based on the fact that the unit of the PCR is 1/27000000 seconds. Also, a user “action” (Play) and the “time” when the user performed the action (2000 Dec. 31 19:00:00) is recorded in the history logs of the history log 1405 of the user “USER-ID-00002”, further, an example where history logs concerning Fwd (forwarding) and Rwd (rewinding) are calculated as the information for identifying the part of the contents on which special playback is performed.

Up to this point, the right management server 101b, the content distribution server 101c and the history log management server 101e in the distribution center 101 will be explained with reference to FIG. 2 to FIG. 14. Detailed structures of the charging server 101a and the web server 101d of the distribution center 101 are omitted here because they are not focused on in this invention.

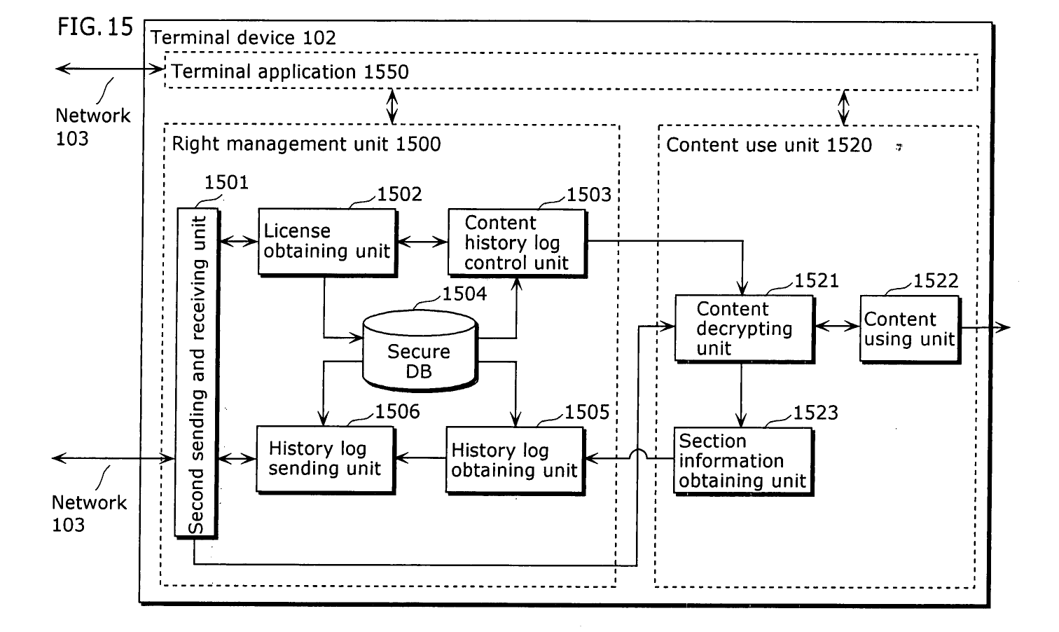

Next, the structure of the terminal apparatus 102 in the content history log collecting system 1 will be explained. FIG. 15 is a functional block diagram showing the detailed structure of the terminal apparatus 102 shown in FIG. 1.

The terminal apparatus 102 comprises a right management unit 1500 for processing a (LT 700) license and performing content use control securely, a content using unit 1520 for using the contents securely and the terminal application 1550 for mainly providing the interface to the user.

The right management unit 1500 comprises the second sending and receiving unit 1501, a license obtaining unit 1502, a content use control unit 1503, a secure DB 1504, the history log obtaining unit 1505 and a history log sending unit 1506. Also, the content using unit 1520 comprises a content decrypting unit 1521, a content using unit 1522 and the section information recording unit 1523.

The second sending and receiving unit 1501 communicates with the distribution center 101 via the network 103.

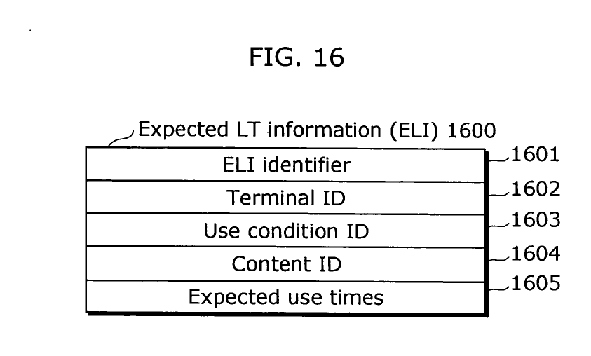

The license obtaining unit 1502 obtains an LT 700 from the right management server 101b. More specifically, the license obtaining unit 1502 generates an Expected LT Information (written as ELI below) shown in FIG. 16 and obtains the LT 700 from the right management server 101b by sending the ELI 1600 to the right management server 101b.

In FIG. 16, the ELI 1600 comprises an ELI identifier 1601, a terminal ID 1602, a use condition ID 1603, a content ID 1604 and an expected use times 1605. The information indicating that this data is the ELI 1600 is written in the ELI identifier 1601. The terminal ID of the terminal apparatus 102 that requests for the LT 700, that is, the terminal apparatus 102 which generated the ELI 1600 is written in the terminal ID 1602. The use condition ID 502 for identifying user use condition managed in the use condition DB 203 of the right management server 101b is written in the use condition ID 1603. This use condition ID 502 uses the use condition ID sent in the response when a user inquires an available right from the right management server 101b. The content ID of the desired contents is written in the content ID 1604. The value of the content available times to be set in the counter for times 722 in the LT action tag block 702 of the requested LT 700 is written in the expected use times 1605. Note that it is also possible to request the expected LT validated period by a user (the LT validated period 715 in the LT header 701) in addition to the expected use times 1605.

The content use control unit 1503 performs content use control securely based on the LT 700. More specifically, the content use control unit 1503 judges whether the contents is available or not based on the use condition included in the LT 700 which is obtained from the right management server 101b by the license obtaining unit 1502 when a user requests the content use control unit 1503 to use the contents. After that, the processing of passing a content key for decrypting encrypted contents to the content decrypting unit 1521 as long as the use condition permits the content use.

For example, the content use control unit 1503 judges whether the contents is available or not referring to the LT validated period 715 set in the LT header 701 of the LT 700 and the counter for times 722 set in the LT action tag block 702. It refers to the present time provided by the secure timer unit, which is not shown in FIG. 15, stored in the terminal apparatus 102 and performs a processing of judging that it is possible to play back a content as long as the present time is within the LT validated period 715 and the value of the counter for times 722 is not less than 1.

As the content key is sent and received securely between the content use control unit 1503 and the content decrypting unit 1521, a SAC is established and then the content key is sent and received securely. However there is no need to establish the SAC in the case where the content use control unit 1503 and the content decrypting unit 1521 are in the same tamper-proofed part because the content key can be sent or received securely.

Also, the content use control unit 1503 generates the history log of the contents as a result of the content use control. More specifically, the content use control unit 1503 performs a processing of generating the history log such as user's content use times (such as playback) or the content use time and then sending it to the history log obtaining unit 1505.

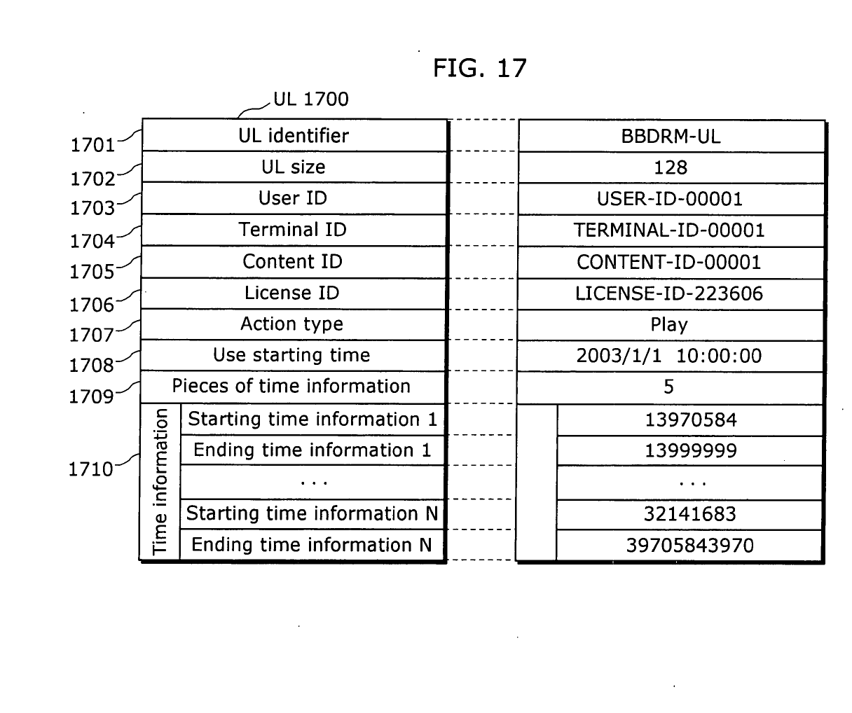

The secure DB 1504 is a database unit operable to manage data securely and stores the LT 700 obtained by the license obtaining unit 1502 and the Usage Log (written as UL from here), that is, the content history log obtained by the history log obtaining unit 1505. Note that the structure of the UL will be explained in detail with reference to FIG. 17. More specifically, the secure DB 1504 stores the LT 700 obtained from the right management server 101b shown in FIG. 7 and the LT 700 or the hash value of the UL in the secure DB 1504 in the tamper-proofed part at hardware level or software level so as to an illicit act such as manipulation.

The first history log obtaining unit 1505 collects the history log from the content use control unit 1503 and the content using unit 1522. More specifically, the history log obtaining unit 1505 receives the history logs obtained by the content use control unit 1503 or the content using unit 1522, records them in the secure DB 1504. Note that it is also possible to send history logs directly to the history log sending unit 1506 without recording them in the secure DB 1504 so as to send them immediately to the history log distribution center 101.

The history log sending unit 1506 is a unit operable to send history logs recorded in the terminal apparatus 102 to the distribution center 101, sets the recorded history logs in the UL and sends them to the history log colleting server 101e. More specifically, the history log sending unit 1506 searches the secure DB 1504 periodically or at an arbitrary timing and obtains the history logs (UL) uploadable to the history log collecting server 101e by referring to the history log response condition 813 included in the tag block for indicating history log collection 704 of the LT 700. For example, a method for searching the associated UL using the LT 700, ID or the like makes it possible to obtain the corresponding UL. Note that it is also possible to send the UL based on the conditions specified except the LT 700 or send the UL based on the predetermined conditions at this time. The UL obtained in this way is sent to the history log collecting server 101e. Also, the history logs received from the history log obtaining unit 1505 can be immediately sent to the history log collecting server 101e using the UL.

On the other hand, the content using unit 1520 comprises a content decrypting unit 1521, a content using unit 1522 and a section information recording unit 1523.

The content decrypting unit 1521 decodes the contents and obtains history logs such as playback location in the contents.

More specifically, the content decrypting unit 1521 obtains the contents multiplexed by the encrypted MPEG-2 TS and obtains the PID of the TS packet 1100 where the TS packet 1100 including the video, sound and data of the contents and the PCR 1125a are inserted by referring to the PSI information such as the PAT (Program Accosiation Table) and the PMT (Program Map Table) included in the transport stream.

After that it decrypts the encrypted payload of the TS packet 1100 using a content key to be obtained from the content use control unit 1503 with reference to the Transport_Scrambling_Control (not shown in FIG. 11) in the TSP Header 1110. At the same time, by referring to the PCR_PID (showing the PID where the PCR is included) that is written in the PMT, the content decrypting unit 1521 obtains the TS packet 1100 with the PID, the TS packet 1100 includes Adaptation_field 1120 where PCR1125a is inserted and obtains the value of the PCR 1125a when a user operation is performed as the starting time information or the ending time information. For example, the value of the PCR 1125a at the starting or ending point of viewing the contents is obtained as the starting or ending time information and sent to the section information recording unit 1523. Also, as to forwarding and rewinding, the values of the PCR 1125a at the starting or ending point of these operations are obtained as the starting or ending time information and sent to the section information recording unit 1523.

The content using unit 1522 decodes the contents and outputs on a monitor that is not shown in FIG. 15. More specifically, the content using unit 1522 obtains the PCR 1125a in the transport stream and synchronizes the STC (timer unit 907) of the content distribution server 101c with the STC (not shown in any figure) owned by the content using unit 1522 using the Phased Lock Loop (PLL) function owned by the content using unit 1522. After that, it obtains the data of the PES packet 1000 from the TSP Payload 1130 of the TS packet 1100, decodes the ES such as video, sound and data of the MPEG-2 and the MPEG-4 and outputs it on a monitor. Also, on finishing the content use, it sends a sending end notification to the content use control unit 1503.

The section information recording unit 1523 records the first time information obtained in the content decrypting unit 1521. More specifically, the section time recording unit 1523 obtains the value of the first time information at the time of starting and ending time of using contents from the content decrypting unit 1521 as the starting time information and the ending time information and sends the section information to the history log obtaining unit 1505 at an appropriate timing such as at the time of ending the content use.

Each units for processing data that especially require security of the terminal apparatus 102, more specifically, the license obtaining unit 1502, the content use control unit 1503, the secure DB 1504, the history log obtaining unit 1505, the history log sending unit 1506, the content decrypting unit 1521, the content using unit 1522 and the section information obtaining unit 1523 are, in general, realized in a form of a system LSI which is tamper-proofed at hardware level or a program which is tamper-proofed at software level so as to avoid illicit use by a malicious user.

The secure DB 1504 manages an identification (terminal ID) that is capable of identifying the terminal apparatus 102 in the content history log collecting system 1, but an identification that is capable of identifying the right management unit 1500 in the content history log collecting system 1 may be used as the terminal ID when the right management unit 1500 is detachable from the terminal apparatus 102.

Up to this point, the detailed structure of the terminal apparatus 102 will be explained with reference to FIG. 15.

Here, the structure of the UL 1700 that has a data structure that enables the history log obtaining unit 1505 to send it to the distribution center 101 will be explained in detail with reference to FIG. 17.

FIG. 17 is a diagram showing an example of the structure of the UL 1700 and comprises a UL identifier 1701 that is an identifier capable of identifying each user uniquely, a UL size 1702 showing the size of the whole UL 1700, a user ID 1703 for identifying a user who generated the UL 1700, a terminal ID 1704 for identifying the terminal apparatus 102 which generated the UL 1700, a content ID 1705 for associating the content used by a user with the UL 1700, a license IS 1706 for associating the license (LT 700) used by a user with the UL 1700, an action type 1707 for identifying the description (type) indicating how a user used the contents, a use starting time 1708 that is an absolute time when a user started using the content, a pieces of time information 1709 showing the number of time information 1710 set in the UL 1700 and a time information 1710 including the starting time information and the ending time information that are the values of the first time information (the PCR 1125a of the TS packet 1100) at the time of starting and finishing using the contents obtained by the content decrypting unit 1521.

Here, for example, the license ID 1706 can use the UL 1700 which has the license ID 1706 that corresponds to the license ID 712 of the LT 700 where conditions specifying returning history logs when collecting the UL 1700 from the terminal apparatus 102 to the history log collecting server 101e are written. Also, as it is possible to identify the LT 700 used by a user based on the UL 1700, in the content history log collecting system capable of returning the LT 700 to the right management server 101b, it is possible to manage the history logs associating with the information included in the LT 700 owned by the user (such as a LT validated period 715) in the distribution center 101. Here is shown an example where the “LICENCE-ID-223606” set in the license ID 712 of the LT 700 that authorizes the use of this contents is set in the license ID 1706.

Also, the action type 1707 is a type for identifying a user action performed on the contents such as “playback”, “copy”, “print” and the like, the value of the action ID 721 of the LT 700 is set in it. Here is shown an example of “Play” that shows playback of the contents.

Further, the time information 1710 is the information for identifying the part of the contents used by the user and the same number of pairs of the starting time information that is the information showing the start of using the contents and the ending time information that is the information showing the end of using the contents as the number of these pairs set in the pieces of time information 1709 are included in the time information 1710. Here is an example where 5 pairs of “starting time information” and “ending time information” are included, “starting time information 1, ending time information 1” is “13970584, 13999999”, and “starting time information 5, ending time information 5” is “32141683, 39705843970”.

Note that no hash value for detecting a manipulation of the UL 1700 is included in the UL 1700, but additional manipulation detection may be performed as necessary.

Up to this point, the detailed structure of the UL 1700 that has data structure for sending history logs including the section information from the terminal apparatus 102 to the history log collecting server 101e has been explained with reference to FIG. 17.

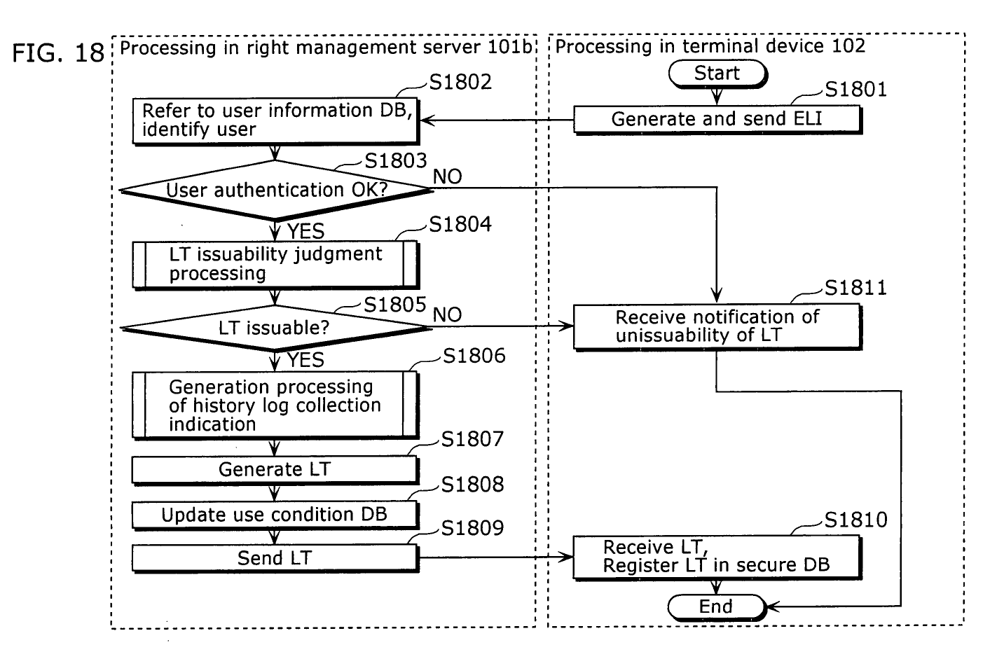

A series of operations that a user obtains the LT 700 from the right management server 101b, uses contents securely, records the section information that is the information for specifying the viewing location of the contents as history logs and sends the history logs from the terminal apparatus 102 to the history log collecting server 101e will be explained with reference to the flow chart shown in FIG. 18 to FIG. 24.

The user needs to perform processing of registering himself or herself as a member to the service provider using a web server 101d and needs to perform a processing of purchasing content use conditions and the like before the user obtains an LT 700 from the right management server 101b, but the explanation on the processing will be omitted in the following explanation because it is not focused on in the present invention.

First, a user operation of obtaining the LT 700 from the right management server 101b in the terminal apparatus 102 will be explained using a flow chart shown in FIG. 18.

When a user obtains user's use condition list managed in the right management server 101b using a user interface unit provided by the terminal application 1550 and selects the use condition of the desired contents from the use condition list, the terminal apparatus 102 generates an ELI 1600 for requesting for the LT 700 corresponding to the use condition to the right management server 101b and sends it to the right management server 101b (step S1801).

More specifically, the content using unit 1522 receives a content ID of the contents which is made available by the use condition selected by the user from the terminal application 1550 and sends it to the content use control unit 1503. The content use control unit 1503 sends the content ID to the license obtaining unit 1502, and the license obtaining unit 1502 generates the ELI 1600 shown in FIG. 16 based on the content ID received from the content use control unit 1503.

The use condition ID 1603 set in this ELI 1600 is considered to be obtained when the terminal application 1550 or the right management unit 1500 inquires the use condition owned by a user via the right management server 101b or the web server 101d. Also, the expected use times 1605 may be set at the value desired by the user via the terminal application 1550 or at the value determined by utilizing a services. The ELI 1600 generated in this way is sent to the right management server 101b via the second sending and receiving unit 1501.

The license issuing unit 212 of the right management server 101b receives the ELI 1600 from the terminal apparatus 102, refers to the user information DB 201, identifies a user and performs a user authentication (step S1802).

More specifically, the user authentication is performed in two steps. In general, when exchanging data that requires security like an LT 700, an SAC is established so as to communicate securely. Therefore, as the first step, a SAC is established between the right management server 101b and the terminal apparatus 102. In order to establish a SAC, it is possible to use the SSL or the Transport Layer Security (TLS) or the like. This mutual authentication enables the right management server 101b to confirm that the terminal apparatus 102 has a right terminal ID 1602.

As the second step, the license issuing unit 212 identifies a user who owns the terminal apparatus 102 whose ID is the terminal ID 1602. Therefore, the license issuing unit 212 obtains the terminal ID 1602 included in the ELI 1600, refers to the user ID 301 and the terminal ID 302 of the user information management table 300 of the user information DB 201 and searches the terminal ID 302 of the user information management table 300 that matches the terminal ID 1602 included in the ELI 1600. When the matching terminal ID 302 is found, it is possible to obtain the relating user ID 301, but when no matching terminal ID 302 is found, the user authentication fails.

The license issuing unit 212 confirms the user authentication result in the step S1802 (step S1803).

In the case where the answer of the step S1803 is YES, in other words, in the case where a user authentication is performed correctly, step S1804 is executed because the use condition for issuing the LT 700 is confirmed.

In the case where the answer of the step S1803 is NO, in other words, in the case where a user authentication is not performed correctly, the LT is judged as unissuable and the license issuing unit 212 sends the notification of unissuability of an LT to the terminal apparatus 102.

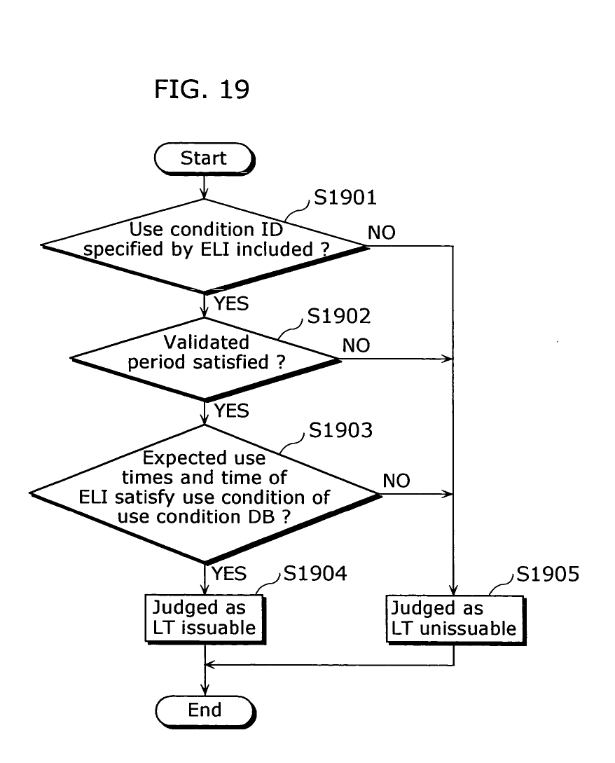

The license issuing unit 212 executes the LT issuability judgment processing (step S1804). This LT issuability judgment processing will be explained in detail with reference to FIG. 19.

The license issuing unit 212 refers to the result of the LT issuability judgment processing and judges whether the LT 700 is issuable or not (step S1805).

In the case where the answer of the step S1805 is YES, in other words, in the case where the LT is judged to be issuable, step S1806 is executed.

In the case where the answer of the step S1805 is NO, in other words, in the case where the LT is judged to be unissuable, the license issuing unit 212 sends the notification of unissuability of the LT to the terminal apparatus 102.

The license issuing unit 212 requests the history log collection indication unit 211 to generate the indication information 803 for collecting the first history log shown in FIG. 8, and the processing for generating history log collection indication is executed in the history log collection indication unit 211 (step S1806). This processing for generating history log collection indication will be explained later in detail with reference to a figure.

The license issuing unit 212 receives the indication information 803 for collecting the history log from the history log collection indication unit 211 and generates the LT 700 (step S1807).

More specifically, the license issuing unit 212 receives the indication information 803 from the history log collection indication unit 211 and generates the tag block for collecting history logs 804. Also, it refers to the ELI 1600 and the use condition management table 500 of the use condition DB 203, obtains the content key 402 corresponding to the content ID 1604 (content ID 401) from the content key management table 400 of the content key DB 202 and generates the LT 700 including the use condition requested by the ELI 1600.

The license issuing unit 212 updates the use condition management table 500 of the use condition DB 203 (step S1808). More specifically, the license issuing unit 212 subtracts the use condition of the user included in the issued LT 700 from the use condition of the user. For example, when the counter for times 722 of the LT action tag block 702 of the LT 700 is “3” on condition that the available times 505 of the use condition management table 500 is “5”, the processing of updating the available times 505 of the use condition management table 500 to “2”.

The license issuing unit 212 sends the LT 700 generated in the step S1807 to the terminal apparatus 102 (step S1809). More specifically, the license issuing unit 212 sends the LT 700 to the terminal apparatus 102 via the first sending and receiving unit 213.

The license obtaining unit 1502 of the terminal apparatus 102 receives the LT 700 from the right management server 101b and registers the LT 700 in the secure DB 1504 (step S1810). More specifically, the license obtaining unit 1502 obtains the LT 700 as a response to the ELI 1600 generated in the step S1801 via the second sending and receiving unit 1501, writes the LT 700 in the secure DB 1504 and updates the hash value of the secure DB 1504.

When a notification of unissuability of the LT is sent because the LT 700 is unissuable, the license obtaining unit 1502 of the terminal apparatus 102 receives the notification of unissuability of the LT in the step S1803 or step S1805 (step S1811). More specifically, the license obtaining unit 1502 of the terminal apparatus 102 receives the notification of unissuability of the LT from the right management server 101b and notifies the user of receiving the notification via a user interface unit of the terminal application 1550 to finish this processing.

Here, the LT issuability judgment processing in the step S1804 will be explained with reference to FIG. 19.

First, the license issuing unit 212 confirms whether the use condition ID 1603 specified by the ELI 1600 is included in the use condition management table 500 of the use condition DB 203 (step S1901). More specifically, the license issuing unit 212 refers to the ELI 1600 received from the terminal apparatus 102 and obtains the use condition ID 1603. It is confirmed whether there is any use condition ID 502 in the use condition management table 500 that matches this use condition ID 1603.

In the case where the answer of the step S1901 is YES, in other words, in the case where the use condition ID 502 that matches the use condition ID 1603 of the ELI 1600 is included in the use condition management table 500, it is further confirmed whether the user ID 501 that has the use condition ID 502 matches the user ID 301, which is authenticated in the step S1802 in FIG. 18, in the user information management table 300 of the user information DB 201. Here, step S1902 is executed when the user IDs match each other, or step S1905 is executed when the user ID do not match each other.

In the case where the answer of the step S1901 is NO, in other words, in the case where no use condition ID 502 that matches the use condition ID 1603 of the ELI 1600 is included in the use condition management table 500, step S1905 is executed.

Next, the license issuing unit 212 judges whether the user use condition satisfies the validated period or not (step S1902). More specifically, the license issuing unit 212 refers to the validated period 504 in the use condition management table 500 of the use condition DB 203, obtains the present time from the secure timer unit (not shown in FIG. 2) and judges whether the present time is included in the period between the starting date and time and the finishing date and time shown by the validated period 504.

For example, when the present time is “2002 Dec. 18 12:34:56” on condition that the validated period 504 in the use condition management table 500 is “2002 Dec. 20 12:12:12”, it is judged that the user use condition is within the validated period. On the other hand, when the present time is “2002 Dec. 31 19:00:00”, it is judged that the user use condition is not within the validated period.

In the case where the answer of the step S1902 is YES, in other words, in the case where the user use condition is within the validated period, step S1903 is executed.

In the case where the answer of the step S1902 is NO, in other words, in the case where the user use condition is not within the validated period, step S1905 is executed.

The license issuing unit 212 judges whether the expected use times 1605 of the ELI 1600 is within the use condition owned by a user (step S1903). More specifically, the license issuing unit 212 confirms whether the expected use times 1605 specified by the ELI 1600 is within the available times 505 of the use condition management table 500 or not. For example, when the expected use times 1605 specified by the ELI 1600 is “3” on condition that the available times 505 of the use condition management table 500 is “5”, it is judged that the expected use times 1605 specified by the ELI 1600 is included in the user use condition. On the other hand, the expected use times 1605 specified by the ELI 1600 is “10”, it is judged that no expected use times 1605 specified by the ELI 1600 is included in the user use condition.

In the case where the answer of the step S1903 is YES, in other words, in the case where the expected use times 1605 is included in the user use condition, step S1904 is executed.

In the case where the answer of the step S1903 is NO, in other words, in the case where the expected use times 1605 is not included in the user use condition, step S1905 is executed.

The license issuing unit 212 judges that the LT 700 is issuable and finishes the LT issuability judgment processing (step S1904).

Also, in the case where the answers of the step S1901 to S1903 are NO, in other words, in the case where the license issuing unit 212 judged that the LT 700 is unissuable, the LT issuability judgment processing is finished (step S1905).

Up to this point, the LT issuability judgment processing has been explained with reference to FIG. 19.

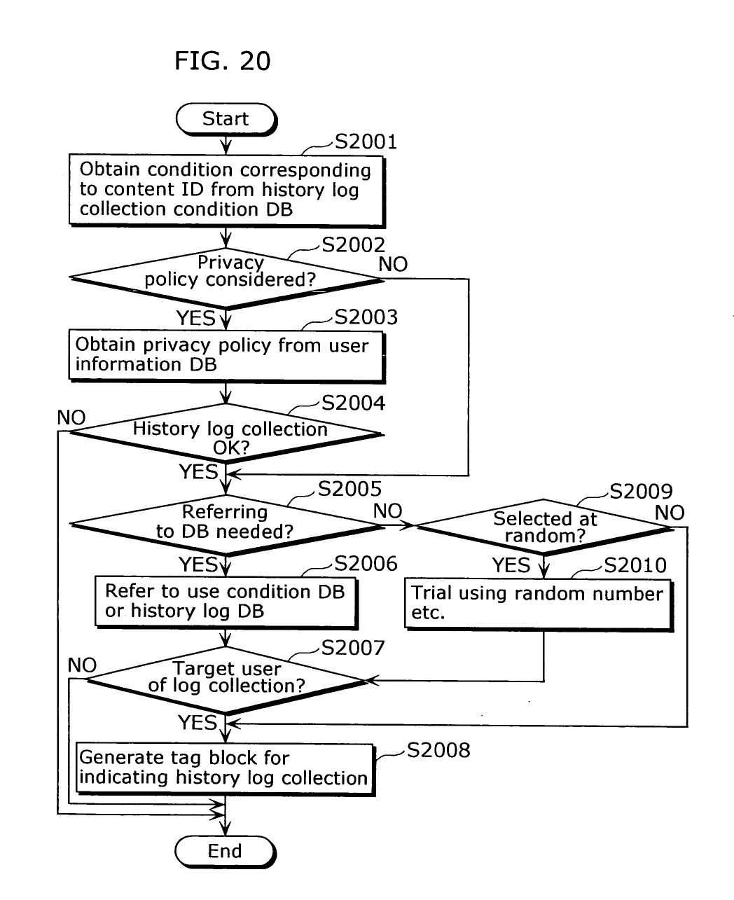

Also, the processing for generating history log collection indication in the step S1806 will be explained with reference to FIG. 20.

The history log collection indication unit 211 obtains the history log collection condition 602 and the like corresponding to the content ID 1604 specified by the ELI 1600 from the history log collection condition DB 204 (step S2001). More specifically, the history log collection indication unit 211 refers to the history log collection condition management table 600 of the history log collection condition DB 204 and obtains the history log collection condition 602 whose content ID 601 matches the content ID 1604 specified by the ELI 1600.

Next, the history log collection indication unit 211 judges whether the target user determination condition 603 of the history log collection condition 602 obtained in the step S2001 needs to consider the user's privacy policy or not (step S2002). More specifically, the history log collection indication unit 211 refers to the target user determination condition 603 and judges whether the privacy policy set by the user needs to be considered when collecting the history log concerning the contents or not. For example, here is an example case where the target user determination condition 603 whose content ID 601 is “CONTENT-ID-00003” in FIG. 6 is set in a way that the privacy policy is considered.

In the case where the answer of the step S2002 is YES, in other words, in the case where the user privacy policy needs to be considered, step S2003 is executed.

In the case where the answer of the step 52002 is NO, in other words, in the case where the user privacy policy needs to be considered, step S2005 is executed.

The history log collection indication unit 211 refers to the user information DB 201 and obtains the user privacy policy (step S2103). More specifically, the history log collection indication unit 211 obtains the privacy policy 304 in the user information management table 300 in the user information DB 201.

The history log collection indication unit 211 refers to the privacy policy 304 obtained in the step S2003 and judges whether the user permits the service provider to collect history logs or not (step S2004). More specifically, when the privacy policy 304 is “history log collecting OK”, the history log collection indication unit 211 judges that collecting the history log is permitted. On the other hand, when the privacy policy 304 is “history log collecting NG”, it judges that collecting the history log is rejected.

In the case where the answer of the step S2004 is YES, in other words, in the case where collecting the history log is OK, step S2005 is executed.

In the case where the answer of the step S2004 is NO, in other words, in the case where collecting the history log is NG, there is no need to generate the history log record condition 811 and the processing finishes.

The history log collection indication unit 211 further judges whether there is a need to refer to the various databases in the right management server 101b or not so as to determine the user whose history log is to be collected (step S2005). More specifically, the history log collection indication unit 211 refers to the target user determination condition 603 obtained in the step S2001 and judges whether there is a need to refer to the use condition DB 203 or the like. For example, as a user is determined as the target user whose history log is to be collected only when 10 or more user use conditions are included in the use condition DB 203, the target user determination condition 603 of the contents whose content ID 601 in FIG. 6 is “CONTENT-ID-00004” is “10 or more history logs”, an access to the use condition DB 203 occurs.

In the case where the answer of the step S2005 is YES, in other words, in the case where accesses to the databases occur so as to determine the target user whose history logs are to be collected, step S2006 is executed.

In the case where the answer of the step S2005 is NO, in other words, in the case where no access to the database occurs so as to determine the target user whose history log is to be collected, step S2009 is executed.

The history log collection indication unit 211 refers to the database according to the condition written in the target user determination condition 603 and obtains the data concerning the user (step S2006).

The history log collection indication unit 211 judges whether a user is determined as the target user whose history logs are to be collected based on the information obtained from the database (step S2007). More specifically, the history log collection indication unit 211 refers to the data concerning the user obtained in the step S2006 and judges whether it satisfies the target user determination condition 603 or not. For example, in the case of the content ID 601 in FIG. 6, which is the contents whose ID is “CONTENT-ID-00004”, when the total of the user use conditions obtained from the use condition management table 500 of the use condition DB 203 in the step S2006 is “12”, the user is determined as the target user whose history logs are to be collected.

On the other hand, when the total of the user use conditions obtained from the use condition management table 500 of the use condition DB 203 in the step S2006 is “3”, the user is not determined as the target user whose history logs are to be collected because it does not satisfy the target user determination condition 603 of the history log collection condition management table 600. Here is shown an example of referring to the total of user use conditions so as to determine who should become the user whose history logs are to be collected, but it is also possible to refer to the number of history logs managed in the history log DB 1204 of the history log collecting server 101e so as to determine who should become the user whose history logs are collected.

The history log collection indication unit 211 generates a tag block for indicating history log collection 704 (step S2008). More specifically, the history log collection indication unit 211 generates a tag block for indicating history log collection 704 shown in FIGS. 7 and 8 based on the history log collection condition management table 600.

Also, in the case where the answer of the step S2006 is NO, in other words, in the case where the history log collection indication unit 211 refers to the target user determination condition 603 and judges whether a user whose history logs are to be collected is selected at random or not (step S2009).

In the case where the answer of the step S2009 is YES, in other words, in the case where a user whose history logs are to be collected is selected at random, step S2010 is executed.

In the case where the answer of the step S2009 is NO, in other words, in the case where it is judged that the history logs are to be collected from all users, step S2008 is executed so as to generate a tag block for indicating history log collection 704.

The history log collection indication unit 211 performs a trial using random numbers or the like and generates data for selecting a target user whose first history log is to be collected (step S2010). After that, step S2007 is executed.

As the processing for generating history log collection indication of the step S1806 has been explained up to this point, an explanation on the operation for obtaining an LT 700 from the right management server 101b by the terminal apparatus 102 will be finished.

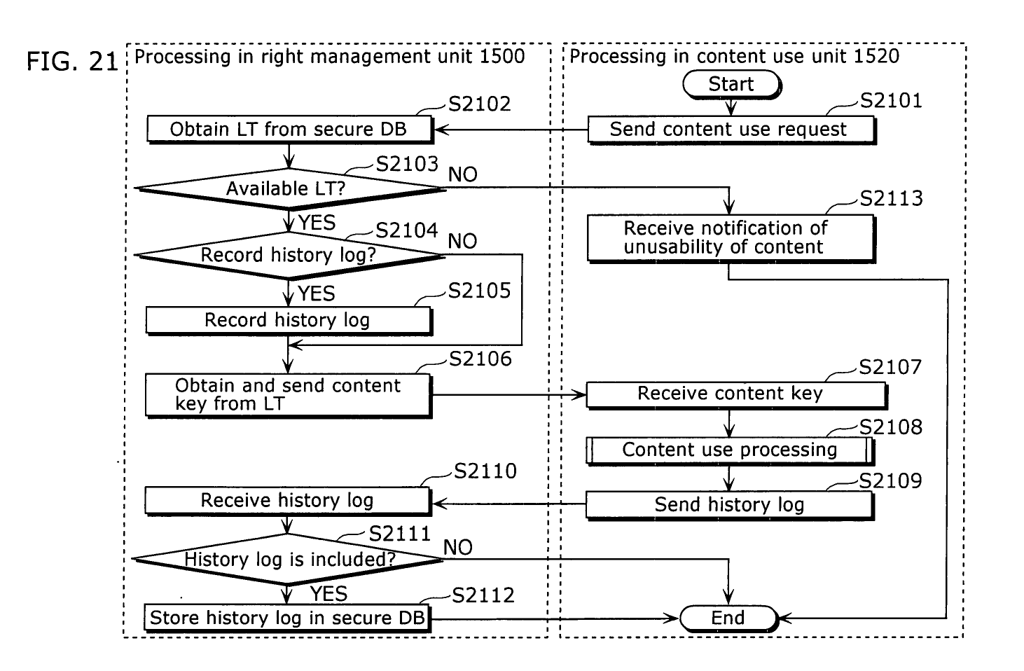

Next, the user operation for using contents and recording the history logs in the terminal apparatus 102 will be explained using the flow chart shown in FIG. 21.

First, a user selects contents for use from the streaming content list on the web display screen provided by the web server 101d or the like via the browser of the terminal application 1550. The content using unit 1520 in the terminal apparatus 102 sends the content ID of the contents received from the terminal application 1550 to the right management unit 1500 (step S2101). More specifically, the content using unit 1522 of the content using unit 1520 receives the Uniform Resource Identifier (URI) showing the content ID selected by the user and the location of the contents from the terminal application 1550, sends the content ID to the content use control unit 1503 of the right management unit 1500 and requests for the content use. The following explanation will be made providing that using contents means playing back contents in the first embodiment of the present invention.

The content use control unit 1503 obtains an LT 700 corresponding to the content ID from the secure DB 1504 (step S2102). More specifically, the content use control unit 1503 searches the secure DB 1504 using the content ID received from the content using unit 1522 as a key.

The content use control unit 1503 obtains an LT 700 corresponding to the content ID from the secure DB 1504 (step S2102). More specifically, the content use control unit 1503 searches the secure DB 1504 making the content ID received from the content using unit 1522 as a key.

The content use control unit 1503 obtains the LT 700 searched in the step S2102 and judges whether it is an available LT 700 or not (step S2103). More specifically, the content use control unit 1503 first confirms whether the LT 700 corresponding to the content ID specified from the content using unit 1522 is included in the secure DB 1504. In the case where the LT 700 is included, it refers to the LT validated period 715 or the counter for times 722 of the LT 700 and confirms the validity of the LT 700. Note that the validity of the LT validated period 715 is confirmed with reference to the time information obtained from the secure timer unit (not shown in FIG. 15) in the terminal apparatus 102. Also, it is confirmed that the value of the counter for times 722 of the LT 700 is “1” or more (including unlimited times). Note that in the case where no LT 700 corresponding to the content ID specified by the content using unit 1522 is included in the secure DB 1504, step S2113 is executed.

In the case where the answer of the step S2103 is YES, in other words, in the case where it is judged that the LT 700 is available, step S2104 is executed.

In the case where the answer of the step S2103 is NO, in other words, in the case where it is judged that the LT 700 is available, step S2113 is executed.

The content use control unit 1503 judges whether the history log should be recorded or not when using the contents (step S2104). More specifically, the content use control unit 1503 detects the presence or absence of a tag block for indicating history log collection 704 of the LT 700 obtained from the secure DB 1504 and determines whether the history log should be recorded or not. Note that it is also possible to determine whether the history log should be recorded or not by referring to the description of the tag block for indicating history log collection 704 or referring to the information concerning another history log collection indication which can be understood by the content use control unit 1503 in addition to the method for determining whether the history log should be recorded or not based on the presence or absence of the tag block for indicating history log collection 704 of the LT 700.

In the case where the answer of the step S2104 is YES, in other words, in the case where it is judged that the history log should be recorded, step S2105 is executed.

In the case where the answer of the step S2104 is NO, in other words, in the case where it is judged that the history log should not be recorded, step S2106 is executed.

The content use control unit 1503 records the history log (step S2105). More specifically, the content use control unit 1503 refers to the history log record condition 811 in the indication information 803 of the tag block for indicating history log collection 704 and records the history logs according to the indication description. For example, as shown in FIG. 8, “action” and “time” are included as the history log description 812, not only the date and time information obtained from the secure timer unit (not shown in FIG. 15) but also “Play” as the action specified by a user are recorded. The history logs recorded in this way are sent to the history log obtaining unit 1505.

The content use control unit 1503 obtains a content key, and sends it to the content decrypting unit 1521 (step S2106). More specifically, the content use control unit 1503 obtains the content key from the content key tag block 703 of the LT 700 and sends it to the content decrypting unit 1521, after establishing a SAC as necessary. The content use control unit 1503 sends, to the content decrypting unit 1521, the “used part” of the history log record condition 811 and the history log description 812 in the indication information 803 included in the tag block for indicating history log collection 704 of the LT 700 at the same time of sending a content key so as to instruct the content using unit 1522 to collect history logs.

Note that it is also possible to send the LT 700 from the content use control unit 1503 to the content decrypting unit 1521 as it is at this time.

The content decrypting unit 1521 receives a content key, (step S2107). More specifically, the content decrypting unit 1521 receives a content key from the content use control unit 1503 and obtains the encrypted contents specified as a URI of the contents obtained from the terminal application 1550.

The content decrypting unit 1521 and the content using unit 1522 performs content decrypting processing and the content use processing (content playback processing) and obtains detailed content history logs (step S2108). More specifically, the content decrypting unit 1521 decrypts the TS packet 1100 decrypted by the content key received from the content use control unit 1503 and at least history logs at the time of starting and finishing using contents are obtained using the PCR 1125a of the TS packet 1100.

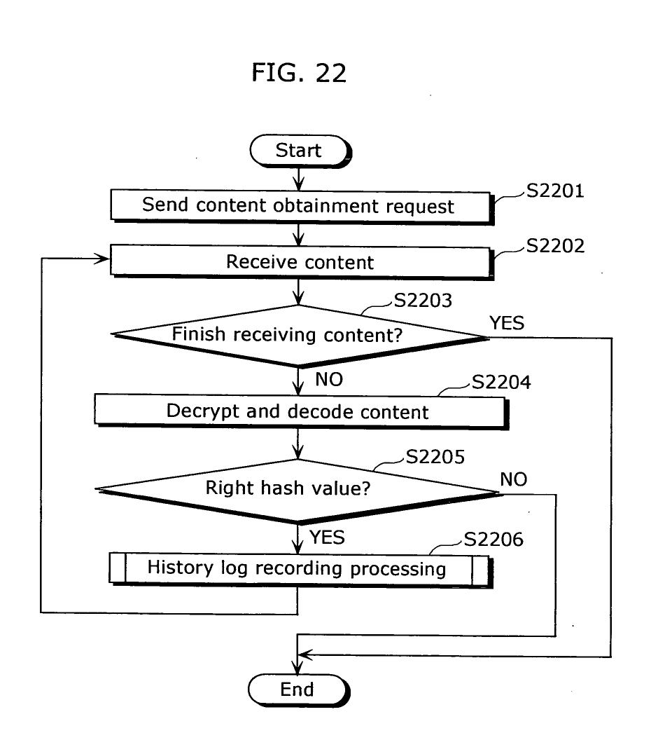

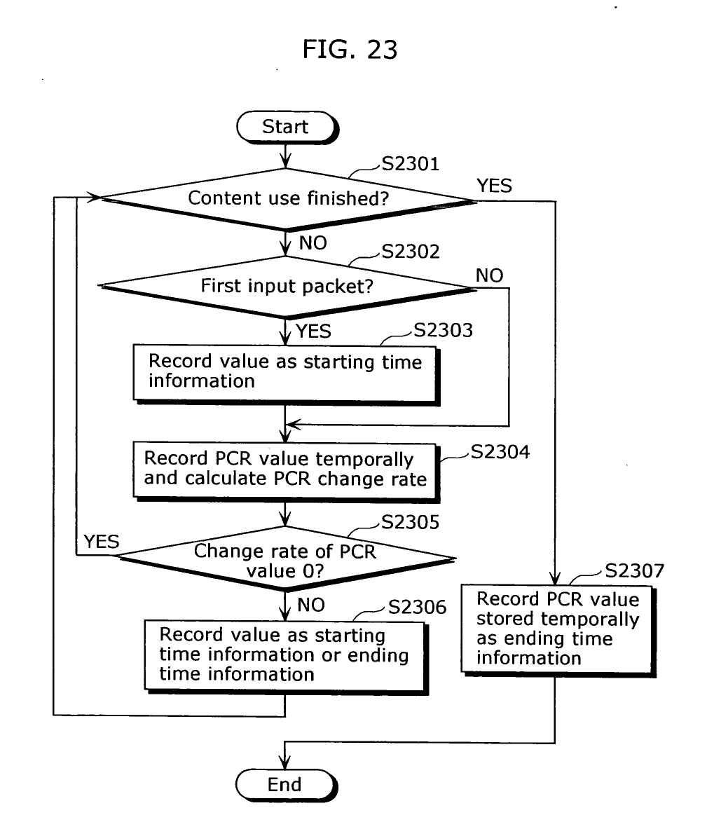

Also, the content using unit 1522 obtains the PES packet 1000 from the TS packet 1100 decrypted in the content decrypting unit 1521, obtains the ES of the contents from the PES packet 1000, decodes it and outputs it on a monitor or the like that is not shown in FIG. 15. This content use processing will be explained later in detail with reference to FIG. 22 and FIG. 23.

The content decrypting unit 1521 sends history logs obtained when using the contents to the history log obtaining unit 1505 (step S2109).

The history log obtaining unit 1505 judges whether valid history logs recorded in the content use control unit 1503 and the content decrypting unit 1521 are obtained or not (step S2111). More specifically, it is the processing for judging whether history logs should be stored in the secure DB 1504 or not because there is a possibility that no history logs are recorded in the step S2104 and step S2108 depending on the description of the indication information 803 of the tag block for indicating history log collection 704 or the presence or absence of the indication information 803.

In the case where the answer of the step 52111 is YES, in other words, in the case where a valid history log is recorded, step S2112 is executed.

In the case where the answer of the step 52111 is NO, in other words, in the case where a valid history log is not recorded, this processing finishes.

The history log obtaining unit 1505 stores the history log in the secure DB 1504 (step S2112). More specifically, the history log obtaining unit 1505 writes the UL 1700, in which history log data 1803 is set, for writing history logs in the secure DB 1504, and updates the secure DB 1504 shown in FIG. 17. At this time, the values of the content ID 714 and the license ID 712 of the LT 700 are used as the content ID 1705 and the license ID 1706 of the UL 1700 respectively.

In the case where there is no available LT 700 in the step S2103, the content using unit 1522 receives a notification of unusability of the contents from the content use control unit 1503 (step S2113). The content using unit 1522 notifies the user of receiving the notification via a user interface unit provided by the terminal application 1550.

Also, in the case where a content use end notification from the content using unit 1522 or any other notification occurs in the step S2110 in FIG. 21, it is possible to record history logs in the content use control unit 1503 or send history logs to the history log obtaining unit 1505. For example, it is possible to obtain history logs concerning “content use end” (that may include time information) at this timing.

Here, the content use processing and the history log recording processing in the step S2108 will be explained with reference to FIGS. 22 and 23.

First, the content use processing and the history log recording processing in the terminal apparatus 102 will be explained with reference to FIG. 22.

The content using unit 1522 sends a content obtainment request to the content distribution server 101c (step S2201). More specifically, the content using unit 1522 connects to the content distribution server 101c based on the URI of the content received from the terminal application 1550 and sends playback request (PLAY) using the RTSP. The content distribution server 101c sets the corresponding contents to the RTP payload and sends them to the terminal apparatus 102 in sequence.

The second sending and receiving unit 1501 receives the contents from the content distribution server 101c (step S2202). More specifically, the second sending and receiving unit 1501 receives these RTP packets sent by the content distribution server 101c in sequence, extracts TS packets from the RTP payload in sequence and sends them to the content decrypting unit 1521.

The second sending and receiving unit 1501 judges whether contents have already been received from the content distribution server 101c or not (step S2203). More specifically, the second sending and receiving unit 1501 detects the end of a stream according to a method such as a method for judging whether the received RTP packet is the last packet or not.

In the case where the answer of the step S2203 is NO, in other words, in the case where contents have not been received yet, step S2204 is executed.

In the case where the answer of the step S2203 is YES, in other words, in the case where a content use end notification is received from a user via the terminal application 1550 or contents have already been received, a notification indicating the fact is sent to a user via the terminal application 1550 and this processing is finished.

The content decrypting unit 1521 decrypts the TS packets 1100 (step S2204). More specifically, the content decrypting unit 1521 decrypts the TS packets 1100 where the payload part (TSP Payload 1130) of the TS packets 1100 received from the second sending and receiving unit 1501 is decrypted. Here, whether the TS packets 1100 are decrypted or not can be judged by referring to the transport_scrambling_control in the TSP Headers 1110.

The content decrypting unit 1521 performs a manipulation check using hashes added to the TS packets 1100 after decrypting TS packets 1100 (step S2205). More specifically, the content decrypting unit 1521 performs a hash value manipulation check using the same method as the hash value calculation performed in the content distribution serer 101c after decrypting TS packets 1100. In other words, it calculates hashes of the PCR 1125a and the TSP Payload 1130 and judges whether it matches the hash value set in the Private Data 1125e of the TS packet. Note that there is no need to perform this processing on the TS packets 1100 except the ones where Adaptation Field 1120 is included and the PCR 1125a is set.

In the case where the answer of the step S2205 is YES, in other words, in the case where the hash value is right, step S2206 is executed.

In the case where the answer of the step S2205 is NO, in other words, in the case where the hash value is not right, content decoding processing and content playback processing are finished and the fact is notified to the terminal application 1550. Here, in the case where the hash value is not right, it is possible to record the fact as the history logs and continues content decoding and playing back processing or to record the fact as the history logs and finish content decoding and playing back processing (disable content use). In other words, it is also possible to keep using the contents or finish using the contents in a way that the part that is not recorded as history logs, in other words, the part whose hash value is not right is excluded from history logs.

The content decrypting unit 1521 performs history log recording processing (step S2206). This history log recording processing will be explained in detail with reference to figures step S2202 is executed after performing step S2206.

Note that the content using unit 1522 receives decoded TS packet 1100 from the content decrypting unit 1521, obtains the decoded PES packet 1000 from the payload of the TS packet 1100 (TSP Payload 1130), obtains data concerning the video ES or sound ES or the like of the contents, decode the respective ESs, synchronizes video with sound, and outputs it on the monitor that is not shown in FIG. 15. At that time, the content using unit 1522 obtains PCR 1125a of the Adaptation Field 1120 of the TS packet 1100 and performs processing for maintaining stability at a clock speed of the STC inside the content using unit 1522 by using the PLL (that is not shown in FIG. 15). Therefore, it is possible to play back contents correctly by decoding and displaying the PES Packet Data Bytes 1060 of the PES packet 1000, video ES, sound ES and the like when this value of the STC matches the PTS 1043a and the DTS 1043b of the PES packet 1000.

In order to prevent the TS packet 1100 from being changed in the step S2205, manipulation on all the TS packets 1100 where a PCR 1125a is added are checked, for example, it is possible to check manipulations on only the TS packet 100 for recording the PCR 1125a as history logs when the need arises.

Next, history log recording processing of the content decrypting unit 1521 shown in the step S2206 in FIG. 22 will be explained with reference to FIG. 23.

The content decrypting unit 1521 judges whether the content use is finished or not (step S2301). More specifically, the content decrypting unit 1521 checks whether the content using unit 1522 (or content use control unit 1503 is also possible) has already received the content use end notification.

In the case where the answer of the step S2301 is YES, in other words, in the case where the content use is finished, step S2307 is executed.

In the case where the answer of the step S2301 is NO, in other words, in the case where the content use is finished, step S2302 is executed.

The content decrypting unit 1521 judges whether the TS packet 1100 is the first TS packet input or not (step S2302). More specifically, the content decrypting unit 1521 judges whether or not it is the first TS packet 1100 input after a user performed the content use operation (action) such as playback, stop, forwarding, rewinding and the like. This enables the content decrypting unit 1521 to obtain the value of the starting time information to be set in the time information of the UL 1700 that is a history log.

In the case where the answer of the step S2302 is YES, in other words, in the case where the TS packet 1100 under processing is the first TS packet 1100 after the user operation, step S2303 is executed.

In the case where the answer of the step S2302 is NO, in other words, in the case where the TS packet 1100 under processing is the first TS packet 1100 after the user operation, step S2304 is executed.

The content decrypting unit 1521 stores the value of the PCR 1125a of the TS packet 1100 under processing inside as the starting time information (step S2303).

The content decrypting unit 1521 calculates the change rate of the PCRs 1125a values along with temporally recording the PCR 1125a values of the TS packet 1100 under processing (step S2304). More specifically, the content decrypting unit 1521 stores the PCR 1125a value of the latest TS packet 1100 that is processed inside so as to obtain the value of the PCR 1125a at the time of finishing content use. Also, using the value of this temporally recorded PCR 1125a, the changing rate of the former PCR 1125a value and the PCR 1125a value of the TS packet 1100 under processing are calculated.

The content decrypting unit 1521 judges whether the change rate of the PCR 1125a value is constant or not (step S2305). More specifically, the content decrypting unit 1521 monitors the change rate of the PCR 1125a value calculated in the step S2304, and checks whether the change rate is “0” or other than “0”. In other words, provided that the change rate is “0”, which means that the TS packet 1100 is inputted to the content decrypting unit 1521 at a constant rate, it is possible to recognize that normal playback is being continued during the normal playback and that forwarding is being continued during the forwarding.

On the other hand, in the case where the change rate is a positive value excluding “0”, or a negative value, the rate of the TS packet 1100 to be inputted is changed, it is possible to recognize that the status has changed from normal playback to forwarding or forwarding to normal playback. As the case where a loss of the TS packet 1100 or PCR jitters occur, it is possible to store, average a certain range of the PCR 1125a values so as to perform judgment processing.

In the case where the answer of the step S2305 is YES, in other words, in the case where the change rate of the PCR 1125a is “0”, step S2302 is executed.

In the case where the answer of the step S2305 is NO, in other words, in the case where the change rate of the PCR 1125a is not “0”, step S2306 is executed.

The content decrypting unit 1521 obtains the value of the PCR 1125a that is temporally stored in the step S2304 and stores the starting time information or the ending time information (step S2306). More specifically, it obtains the PCR 1125a of the latest TS packet 1100 in the TS packet 1100 that has already processed and stored in the content decrypting unit 1521, the content decrypting unit 1521 obtains the value of the starting time information or the ending time information set in the time information of the UL 1700 that is a history log.

As to judgment whether the obtained PCR 1125a value is the starting time information or the ending time information or not, it is possible to judge whether the value is the starting time information or the ending time information according to whether the change rate of the PCR 1125a value is positive or negative by the content decrypting unit 1521 managing the processing status such as under playback, forwarding and rewinding inside. For example, in the case where the change rate of the PCR 125a value is positive under playback, forwarding is regarded as performed and the value is recorded as the ending time information of the Play and recorded as the starting time information of Forwarding (Fwd). Also, at this time, in the case where the history log record condition 811 specified by the LT 700 is “special playback excluded”, there is no need to perform processing for recording the value as the starting time information of Forwarding (Fwd).

The content decrypting unit 1521 records the PCR 1125a value that is temporally stored as the ending time information (step S2307). More specifically, the content decrypting unit 1521 stores the PCR 1125a value that is temporally stored inside in the step S2304 as the ending time information set in the time information of the UL 1700 that is a history log in the case where the content use end notification is made.

Note that it is possible to monitor the change of the PCR 1125a in succession using the PCR 1125a value that is temporally stored inside. For example, it is possible to nullify the history log record (not to record), record a history log of the manipulation and cancel the content decrypting processing because it is possible to detect that illicit switching of the TS packet 1100 has performed in the case where the intervals of the PCR 1125a values are monitored and the values of the PCR 1125a that should be the ones of monotone increasing is decreased.

Up to this point, the processing for recording the content use starting time and ending time in the content decrypting unit 1521 has already been explained with reference to FIG. 23.

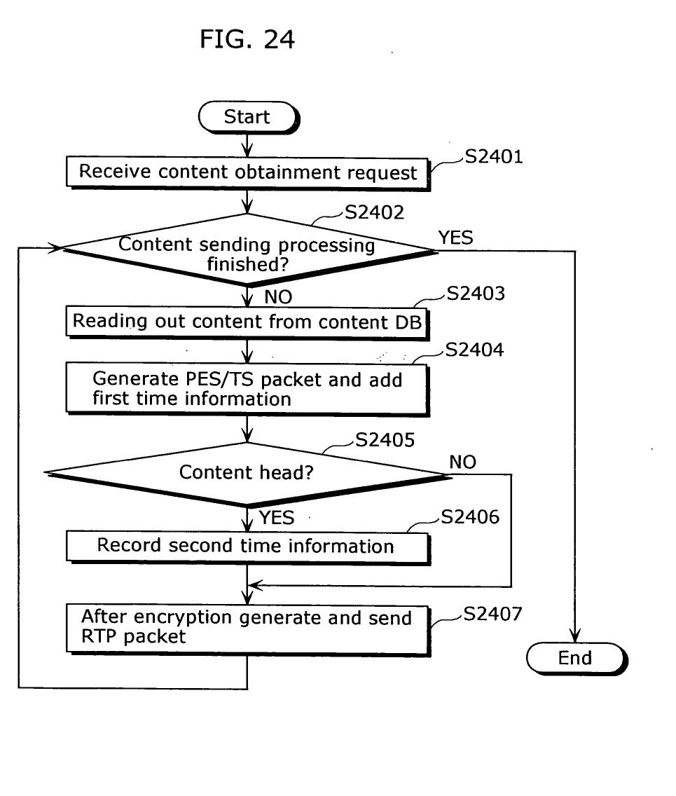

Next, the content sending processing of the content distribution server 101c when the terminal apparatus 102 uses the contents will be explained with reference to FIG. 24.

The content obtainment request receiving unit 901 in the content distribution server 101c receives content obtainment request from the terminal apparatus 102 (step S2401). More specifically, the content obtainment request receiving unit 901 receives playback request by the RTSP from the terminal apparatus 102, obtains the requested content ID and send the content ID to the content obtaining unit 902.

The content sending unit 910 judges whether the contents have been sent or not (step S2402). More specifically, the content sending unit 910 judges whether all the contents have been sent to the terminal apparatus 102 as the RTP packet or not.

In the case where the answer of the step S2402 is NO, in other words, in the case where contents have not been sent yet, step S2403 is executed.

In the case where the answer of the step S2402 is YES, in other words, in the case where all the contents have been sent, the fact is notified to the content obtainment request receiving unit 901 or the like, and this processing is finished.

The content obtaining unit 902 reads out the contents of the content ID from the content DB 903 (step S2403). More specifically, the content obtaining unit 902 searches the content DB 903 making the contents received from the content obtainment request receiving unit 901 as the key and obtain the contents.

The content obtaining unit 902 and the content multiplexing unit 904 generate the PES packet 1000 and the TS packet 1100 in sequence (step S2404). More specifically, the content obtaining unit 902 performs MPEG encoding on video, sound and the like of the contents obtained from the content DB 903 in the step S2403, adds the PTS 1043a and the DTS 1043b for realizing synchronization of the video ES with the sound ES by using an STC obtained from the first time information adding unit 908.

Also, the content multiplexing unit 904 transformed the PES packet 1000 into a TS-packet obtained from the content obtaining unit 902. At this time, the PCR 1125a for synchronizing the system clock of the terminal apparatus 102 with the system clock of the content distribution server 101c (timer unit 907) is assigned using the STC obtained from the first time information adding unit 908. Further, in order to prevent the PCR 1125a from being manipulated, the hash between the PCR 1125a and the payload part (TSP Payload 1130) of the TS packet 1100 is calculated, and the hash is inserted into the private data part (Private Data 1125e) of the TS packet 1100. Further, the content multiplexing unit 904 generates another TS packet 1100 such as PSI (PAT, PMT or the like), null packet or the like and multiplexes it together with the content TS packet 1100 of the contents.

The first time information adding unit 908 judges whether the TS packet 1100 that is performed in the content multiplexing unit 904 is the TS packet 1100 of the head of the contents or not (step S2405). More specifically, the first time information adding unit 908 monitors the flag showing the start of the contents set in the Private Data 1125e of the TS packet 1100 and detects the TS packet 1100 set in the flag.

In the case where the answer of the step S2405 is YES, in other words, in the case where the TS packet 1100 under processing is the TS packet 1100 of the head of the contents, step S2406 is executed.

In the case where the answer of the step S2405 is NO, in other words, in the case where the TS packet 1100 under processing is the TS packet 1100 of the head of the contents, step S2407 is executed.

The second time information recording unit 909 records the second time information received from the first time information adding unit 908 (step S2406). More specifically, as the second time information recording unit 909 receives the value of the PCR 1125a (STC) when the first time information adding unit 908 detects the TS packet 1100 of the head of the contents in the step S2405 as the second time information, this second time information is stored inside. Note that the second time information obtained in this way may be sent to the history log collecting server 101e immediately via the LAN 101n, may be sent to the history log collecting server 101e when it is requested from the history log collecting server 101e or may be sent to the history log collecting server 101e at an appropriate timing.

The content encrypting unit 905 and the content sending unit 910 encrypts the TS packet 1100 using a content key, generates the RTP packet and then sends it to the terminal apparatus 102 (step S2407). More specifically, the content encrypting unit 905 encrypts the payload part (TSP Payload 1130) of the TS packet 1100 received from the content multiplexing unit 904 using a content key received from the content key supplying unit 906.

Also, the content key supplying unit 906 receives the content ID of the contents to be sent to the terminal apparatus 102 from the content obtainment request receiving unit 901 and reads out the corresponding content key from the content key DB 911 and passes it to the content encrypting unit 905 together with the content PID. Note that the content PID in this time is used for specifying the TS packet 1100 to be encrypted by the content encrypting unit 905 and processing of passing the PID specified by the content multiplexing unit 904 is performed.

Also, the content sending unit 910 divides (or aggregates) the encrypted TS packet 1100 received from the content encrypting unit 905 into several pieces of a certain size and adds an RTP header to each of them, generate the RTP packets and sends them to the terminal apparatus 102 in sequence. After that, step S2402 is executed.

Up to this point, the operation for sending contents in the content distribution server 101c at the time of using the streaming contents in the terminal apparatus 102 has already been explained.

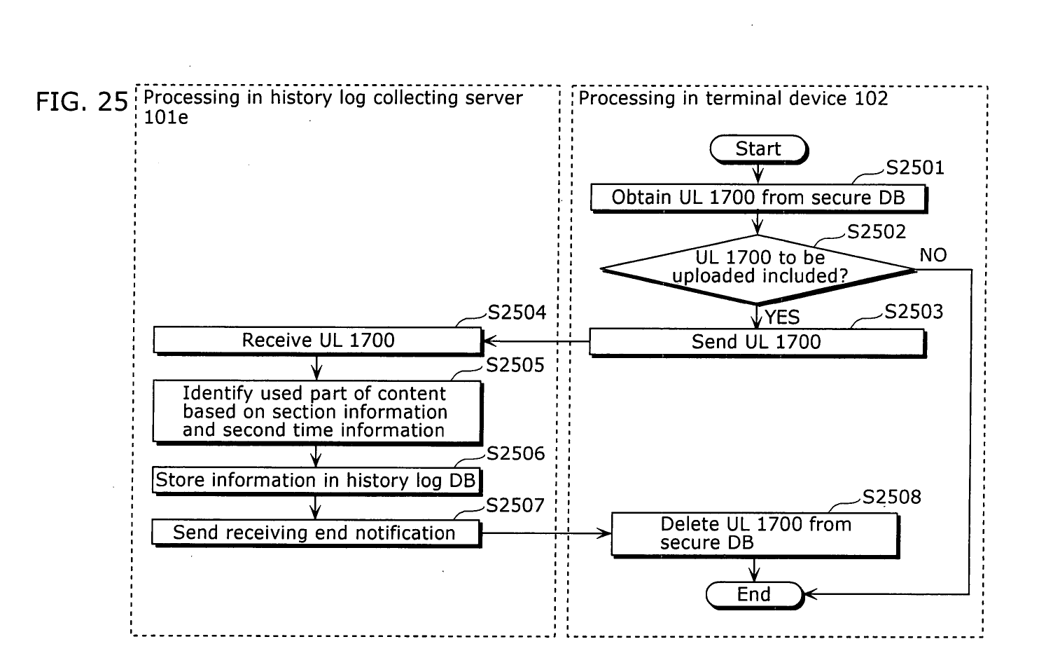

Next, operation for sending the content history logs recorded in the terminal apparatus 102 to the history log collecting server 101e using the UL 1700 will be explained with reference to the flow chart shown in FIG. 25.

The history log sending unit 1506 of the terminal apparatus 102 obtains the history log (UL 1700) to be sent to the history log collecting server 101e from the secure DB 1504 (step S2501). More specifically, the history log sending unit 1506 searches all LT 700 in the secure DB 1504 and refers to the history log response condition 813 in the indication information 803 of the tag block for indicating history log collection 704. Here, in the case where the history log satisfies the response condition, the UL 1700 having the license ID 1706 that corresponds to the license ID 712 in the LT 700 is obtained from the secure DB 1504.

The history log sending unit 1506 confirms the presence or absence of the UL 1700 that is sent to the history log collecting server 101e as a result obtained in the step S2501 (step S2502).

In the case where the answer of the step S2502 is YES, in other words, in the case where there is a UL 1700 to be sent to the history log collecting server 101e, step S2503 is executed.

In the case where the answer of the step S2502 is NO, in other words, in the case where there is no UL 1700 to be sent to the history log collecting server 101e, this processing is finished.

The history log sending unit 1506 sends the history log to the history log collecting server 101e (step S2503). More specifically, the history log sending unit 1506 sends the UL 1700 to the history log collecting server 101e via the second sending and receiving unit 1501. At this time, the terminal apparatus 102 and the history log collecting server 101e establish the SAC using the SSL or the like and send it to the UL 1700. Note that the terminal apparatus 102 and the history log collecting server 101e encrypts the UL 1700 by using a common encryption key and which makes it possible to secure the security of the UL 1700. Using a method such as the SAC in sending the UL 1700 makes it possible to identify the sending resource of the UL 1700.

The section information obtaining unit 1201 in the history log collecting server 101e receives the section time information from the terminal apparatus 102 as a history log (step S2504). More specifically, the section information obtaining unit 1201 receives the UL 1700 from the terminal apparatus 102 via the network 103.

The history log obtaining unit 1203 calculates which part of the contents is used by a user based on the section information and the second time information (step S2505). More specifically, the history log obtaining unit 1203 calculates the difference between the section information set in the UL 1700 received from the terminal apparatus 102 and the second time information received from the content distribution server 101c and obtains information for identifying the used part of the contents. For example, in the case where the second time information is “10000000” when the starting time information and the ending time information of the time information 1710 of the UL 1700 are “13970584” and “13999999” respectively, the used part of the contents is calculated as “3970584” and “3999999” respectively by subtracting the value of the second time information from the value of the starting time information and the ending time information respectively.

As to the second time information, it is possible to request the content distribution server 101c to obtain the second time information as the need arises or to request the history log collecting server 101e to previously obtain and manage it from the content distribution server 10c.

The history log obtaining unit 1203 stores the used part of the contents calculated in the step S2505 and necessary information as history logs such as the user ID and the content ID in the history log DB 1204 (step S2506). More specifically, the history log obtaining unit 1203 stores “3970584” and “3999999” that are content use starting and ending time (relative time from the start of the contents) calculated in the step S2505 in the history log 1405 of the history log management table 1400. At the same time, a user ID 1401, a terminal ID 1402, a content ID 1403 and a license ID 1404 that are shown in FIG. 14 are also stored. Also, in the case where the action type 1707 of the UL 1700 or the use starting time 1708 is set, they are set in the history log 1405 of the history log management table 1400.

The section obtaining unit 1201 sends the receiving end notification of the UL 1700 to the terminal apparatus 102 (step S2507).

The history log sending unit 1506 of the terminal apparatus 102, at the time of receiving the receiving end notification of the UL 1700 from the history log collecting server 101e, updates (commit) the sent secure DB 1504 and completely deletes the UL 1700 sent to the history log collecting server 101e (step S2508).

Up to this point, the operation indicating how the terminal apparatus 102 sends the UL 1700 to the history log collecting server 101e has already been explained.

As shown above, in the content history log collecting system 1, the first time information generated in the distribution center 101 is bound securely and distributed to the terminal apparatus 102, the first time information in the head of the contents is stored in the distribution center 101 as the second time information, and which part of the contents is used by a user is calculated based on the section information collected from the terminal apparatus 102 as a history log and the second time information stored by the distribution center 101. Therefore, a content provider and a service provider can obtain user history logs securely and in detail.

(Second Embodiment)

The second embodiment in the present invention will be explained in detail with reference to figures below.

The first time information and the second time information are assigned to the contents and the used part of the contents is calculated in the terminal device 102 in the content history log collecting system 2 that is later-explained in the second embodiment of the present invention, while the value of the first time information in the head of the contents is stored in the distribution center 101 as the second time information and the used part of the contents is calculated in the distribution center 101 after collecting history logs in the content history log collecting system 1. Explanation on the whole outline structure of the content history log collecting system 2 is omitted here because it is the same as the content history log collecting system 1. Also, explanations on the components that are the same as the first embodiment of the present invention are omitted because they have already been explained in the first embodiment.

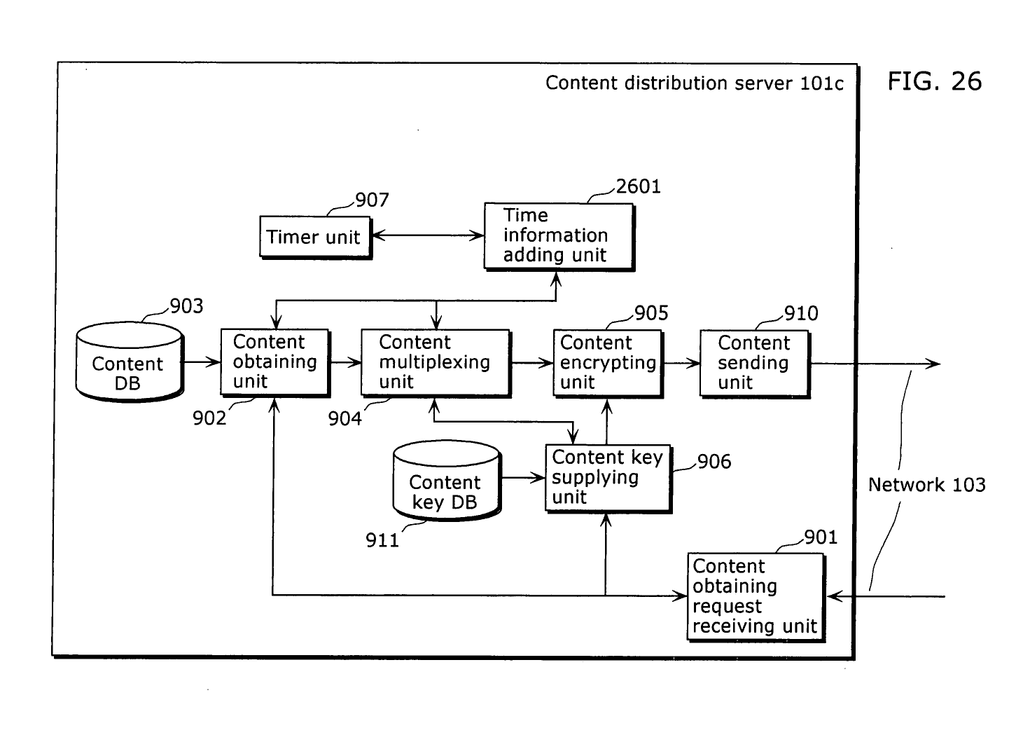

The content distribution server 101c of the distribution center 101 will be explained with reference to FIG. 26. In this figure, components that are the same as the content distribution server 101c of the first embodiment shown in FIG. 9 have already been explained in FIG. 9, reference numbers that are the same as the ones used in FIG. 9 are assigned to the components and the explanations on them are omitted.

The content distribution server 101c shown in FIG. 26 has a time information adding unit 2601 instead of the first time information adding unit 908 in FIG. 9 but does not have the second time information recording unit 909.

The time information adding unit 2601 adds the first time information and the second information to the contents. More specifically, the time information adding unit 2601 obtains the first time information (STC) from the timer unit 907 and assigns a time stamp for the PTS 1043a/DTS1043b of the PES packet 1000 and the PCR 1125a of the TS packet 1100 respectively to the content obtaining unit 902 and the content multiplexing unit 904. This processing is the same as the one performed by the content distribution server 101c in the first embodiment of the present invention. Further, the time information adding unit 2601 obtains the first time information value (that is PCR and STC) at the time of starting the contents as the second time information using the same method as the content distribution server 101c in the first embodiment of the present invention and performs processing for providing the content multiplexing unit 904 with the value.

In addition to the addition processing (setting the PCR 1125a value) of the first time information in the content multiplexing unit 904 shown in the first embodiment of the present invention, the content multiplexing unit 904 sets the second time information obtained from the time information adding unit 2601 to the Private Data 1125e of the TS packet 1100. An appropriate value is set as the Private Data Length 1125d according to the length of the added second time information. Also, the calculation processing of the hash value and the addition processing of the hash value to the Private Data 1125e shown in the first embodiment of the present invention are not performed.

The content encrypting unit 905 performs the same processing as the content encrypting unit 905 in the first embodiment of the present invention excluding the content encrypting method. As the PCR 1125a (the first time information) and the second time information added to the Private Data 1125e are included in the non-encrypted part of the TS packet 1100, there is a fear that values of the first time information or the second time information are illicitly manipulated and the right history logs cannot be obtained in the distribution center 101. Therefore, the content encrypting unit 905 combines a content key for each contents to be managed in the content key DB 911 with the PCR 1125a of the first time information and the second time information so as to use it as an encryption key of the TSP Payload 1130. As this makes the terminal apparatus 102 disable to generate the right encryption key in the case where the first time information set in the non-encrypted part of the TS packet or the second time information are illicitly manipulated, content decrypting processing fails as a result, and thus it is possible to practically prevent the first time information and the second time information from being manipulated. In other words, the content encrypting unit 905 securely binds the first time information, the second time information and the contents.

The method for combining the first time information with the content key may be a simple one because the first time information and the second time information are not secret information. Here is an example where the value of the Exclusive OR (XOR) of the content key, the first time information and the second time information is used as an encryption key of the TSP Payload 1130. In other words, in the case where the encryption mode of the TSP Payload 1130 is a mode that requires an initial vector such as the CBC, it is possible to reduce computational time for generating an expansion key for each TS packet 1100 including the first time information and the second time information in the case where the encryption algorithm is the AES by using the information including at least the first time information and the second time information as an initial vector.

Note that the processing for generating an encryption key by combining the first time information, and the second time information and the content key with each other is performed only on the TS packet 1100 where the PCR 1125a (and the second time information of the Private Data 1125e) is set.

Also, here, an example case where two pieces of time information are combined with a content key in the case where the first time information and the second time information are set in the TS packet 1100, the present invention is not limited to this, and it is applicable also in the case where time information set in the non-encrypted part of the TS packet 1100 is only 1.

Up to this point, the content distribution server 101c of the distribution center 101 has already been explained.

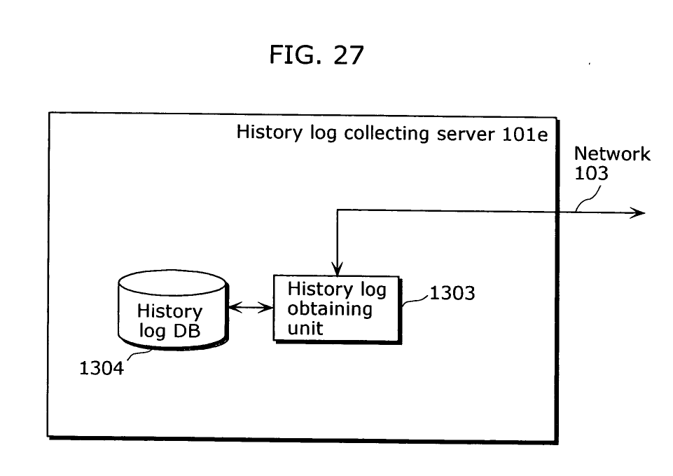

Next, the history log collecting server 101e of the distribution center 101 will be explained with reference to FIG. 27.

The history log collecting server 101e in the second embodiment of the present invention does not have the section information obtaining unit 1201 of the history log collecting server 101e show in FIG. 12 and the second time information obtaining unit 1202 but comprises the history log obtaining unit 1303 and the history log DB 1304.

The history log obtaining unit 1303 receives the history logs from the terminal apparatus 102. More specifically, the history log obtaining unit 1303 receives the UL 1700 from the terminal apparatus 102 via the network 103 and stores the history logs set in the UL 1700 in the history log DB 1304. The processing for calculating the used part of the contents is performed based on the section information that are history logs set in the UL 1700 and the second time information managed in the content distribution server 101c in the first embodiment of the present invention, but in this second embodiment, processing for only storing the descriptions of the UL 1700 is basically performed because the processing for calculating the used part of the contents is performed in the terminal apparatus 102.

Also, explanation on the history log DB 1304 is omitted because it manages the same table as the history log management table 1400 shown in FIG. 14.

Up to this point, explanation on the history log collecting server 101e of the distribution center 101 has finished.

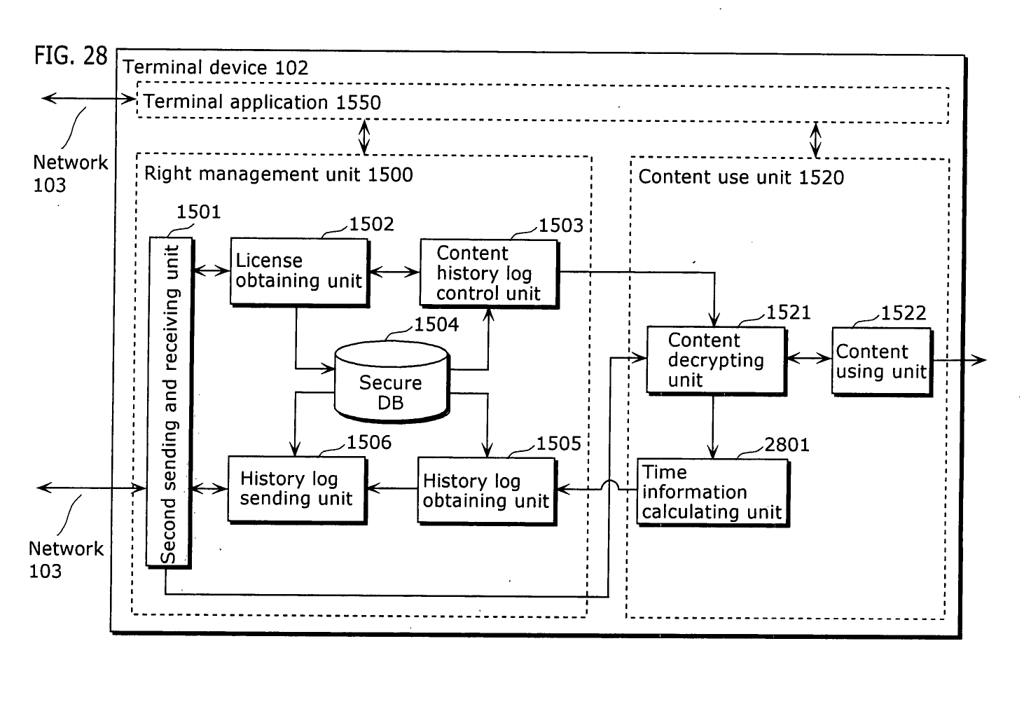

Next, the structure of the terminal apparatus 102 in the content history log collecting system 2 will be explained. FIG. 28 is a functional block diagram showing the detailed structure of the terminal apparatus 102 shown in FIG. 1.

FIG. 28 equips the time information calculating unit 2801 instead of the section information recording unit 1523 of the terminal apparatus 102 shown in FIG. 15. Note that explanation on other components except the content decrypting unit 1521 and the content using unit 1522 is the same as the one in the first embodiment of the present invention and it is omitted here.

The time information calculating unit 2801 receives the first time information obtained in the content decrypting unit 1521 and the second time information, calculates and stores the time information for identifying the used part of the contents (that is the relative time from the head of the contents) based on the first time information and the second time information. More specifically, the time information calculating unit 2801 obtains the value of the first time information at the time of starting and finishing content use from the content decrypting unit 1521 and the second time information that is the value of the first time information at the time of starting the content use, performs processing for subtracting the value of the first time information at the time of starting and finishing content use from the second time information and stores the result as the time information for specifying the used part of the contents. In other words, FIG. 13 is used so as to explain the following processing: the history collecting server 101e stores the value of the second time information (PCR_T) and the history log collecting server 101e calculates (PCR_S−PCR_T) and (PCR_E−PCR_T) in the first embodiment, but as the TS packet 1100 distributes the second time information (PCR_T) in this second embodiment, the time information calculating unit 2801 of the terminal apparatus 102 calculates (PCR_S−PCR_T) and (PCR_E−PCR_T).

The content decrypting unit 1521 shown in FIG. 28 basically performs the same processing as the content decrypting unit 1521 shown in FIG. 15, but it has another content decrypting method different from the method for obtaining time information set in the contents. More specifically, the content decrypting unit 1521 obtains PCR 1125a, and the first time information set in the Private Data 1125e and the second time information from the Adaptation_field 1120 of the TS packet 1100. It generates a decryption key of the TS packet 1100 using these pieces of time information and the content key to be obtained from the content use control unit 1503 (for example, performing XOR) and decrypts the encrypted payload (TSP Payload 1130). Note that the PCR 1125a is not always included in all the TS packet 1100, the processing for generating a decryption key from these pieces of time information and a content key is performed only on the TS packet 1100 where the PCR 1125a is set.

Also, the value of the first time information and the second time information at the time when the user operation is performed are sent to the time information calculating unit 2801. As only effective history logs are recorded, in the case where a notification of decoding processing error or a notification of the decoding status indicating that special playback is being performed, the processing for not sending the value of the first time information or the second time information is performed to the time information calculating unit 2801. Note that here is shown a case of not recording history logs in the case where a decoding processing (playback) failed or special playback is being performed, but it is possible to send the value of the first time information and the second time information along with the decoding status (such as user operation descriptions on forwarding, rewinding or information such as how many times faster the forwarding playback or rewinding playback is performed) to the time information calculating unit 2801 in the case where history logs of decoding processing error or history logs that are being performed are desired to be obtained.

The content using unit 1522 basically performs processing that is the same as the one performed by the content using unit 1522 shown in FIG. 15, but it differs in that it performs processing for notifying the content decrypting unit 1521 of the result of the decoding processing (such as its status). More specifically, as the content using unit 1522 fails decoding a video ES, a sound ES and the like set in the TS packet 1100 that are received from the content decrypting unit 1521 in the case where the first time information or the second time information that is set in the non-encrypted part of the content is manipulated, it performs processing for notifying the content decrypting unit 1521 of the fact. Also, in the case where special playback such as forwarding, rewinding and the like is performed, notifying the content decrypting unit 1521 of the fact enables the content decrypting unit 1521 or the time information calculating unit 2801 and the like to recognize that special playback is performed and determines whether history logs are recorded or not.

Up to this point, the structure of the terminal apparatus 102 has been explained with reference to FIG. 28.

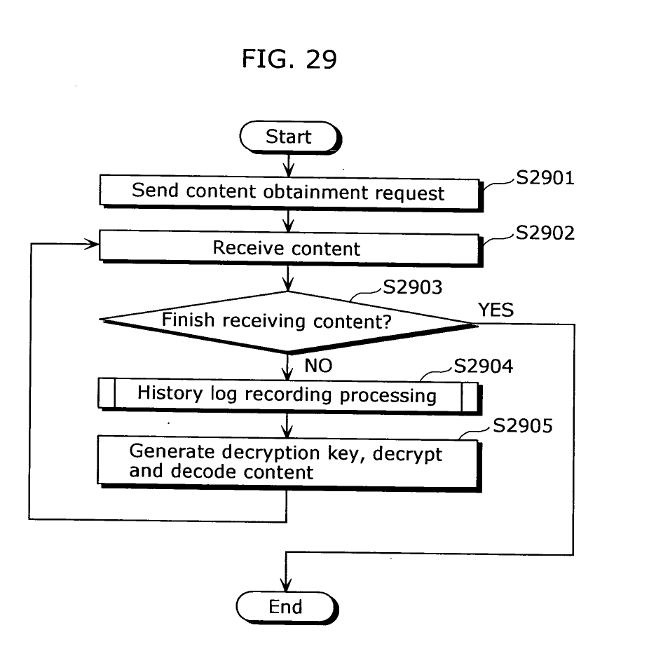

A series of operations, which is performed by the terminal apparatus 102 formed as shown above, will be explained with reference to flow charts shown in FIG. 29 to FIG. 31. The operation is that a user obtains the LT 700 from the right management server 101b and uses the contents securely, records history logs of relative time from the head of the contents that is obtained from the first time information and the second time information and then sends the history logs from the terminal apparatus 102 to the history log collecting server 101e. Note that the whole processing of the processing for obtaining the LT 700 from the right management server 101b in the terminal apparatus 102 and the processing for using contents and recording history logs in the terminal apparatus 102 are the same as the processing performed in FIG. 18 to FIG. 21 in this first embodiment of the present invention respectively and they are omitted here. Also, the processing for sending history logs to the history log collecting server 101e in the terminal apparatus 102 is omitted here because only the processing where history logs recorded in the terminal apparatus 102 are sent to the history log collecting server 101e and the history log collecting server 101e stores the history logs in the history log DB 1304 is performed.

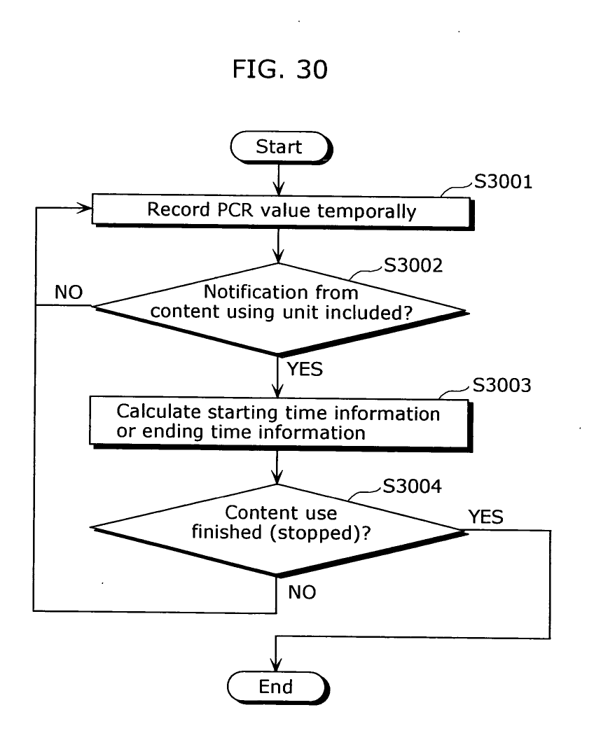

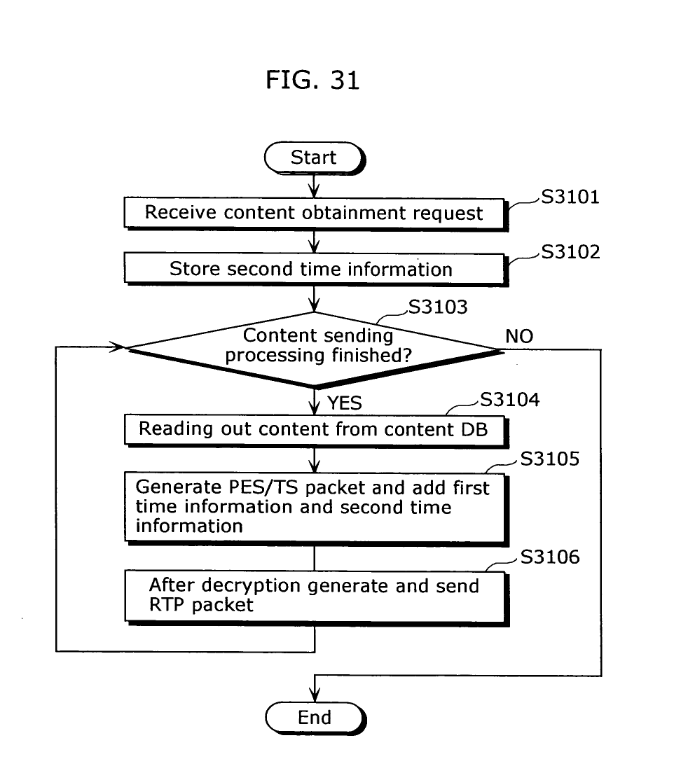

Therefore, here, the content use processing, the detailed processing of the history log recording processing and the stream sending processing in the content distribution server 101c are explained respectively with reference to FIGS. 30 and 31.

First, as to the content use processing and the history log recording processing in the step S2108, FIG. 29 and FIG. 30 show the content use processing and the history log recording processing in the terminal apparatus 102 and FIG. 31 shows the content use processing in the content distribution server 101c.

First, the content use processing and the history log recording processing in the terminal apparatus 102 will be explained with reference to FIG. 29.

The content using unit 1522 sends a content obtainment request to the content distribution server 101c (step S2901). More specifically, the content using unit 1522 connects to the content distribution server 101c based on the URI of the contents received from the terminal application 1550 and sends the playback request (PLAY) using the RTSP. The content distribution server 101c sets the corresponding contents to the payload of the RTP and sends it to the terminal apparatus 102 in sequence.

The second sending and receiving unit 1501 receives contents from the content distribution server 101c (step S2902). More specifically, the second sending and receiving unit 1501 receives RTP packet sent by the content distribution server 101c in sequence, extracts the MPEG-2 TS from the PTP payload and sends it to the content decrypting unit 1521.

The second sending and receiving unit 1501 judges whether receiving contents from the content distribution server 101c has finished or not (step S2903). More specifically, the second sending and receiving unit 1501 detects the end of a stream using a method determining whether the received RTP packet is the last packet or not.

In the case where the answer of the step S2903 is NO, in other words, in the case where receiving the contents have not finished yet, step S2904 is executed.

In the case where the answer of the step S2903 is YES, in other words, in the case where content use end notification is received from a user via the terminal application 1550 or in the case where receiving contents is finished, the fact is notified to the terminal application 1550 and this processing is finished.

The content decrypting unit 1521 generates a decryption key for decrypting contents for each TS packet 1100 and decodes the TS packet 1100 and the content using unit 1522 decodes the contents (step S2905). More specifically, the content decrypting unit 1521 decrypts the TS packet 1100 where the payload part (TSP Payload 1130) of the TS packet 1100 received from the second sending and receiving unit 1501. At this time, in the case where the TS packet 1100 under processing includes the PCR 1125a, the content decryption key is generated by performing XOR on the content key received from the content use control unit 1503, the PCR 1125a (the first time information) and the second time information of the Private Data 1125e. In the case where no PCR 1125a is included, the payload part (TSP Payload 1130) of the TS packet 1100 is decrypted using the content key received from the content use control unit 1503. As to whether the TS packet 1100 includes the PCR 1125a or not, it can be judged by referring to the PCR_Flag 1124 of the Adaptation Field 1120.

The TS packet 1100 where the payload is decrypted is passed to the content using unit 1522 and decoded in sequence.

In the case where the first time information and the second time information included in the content non-encrypted part is manipulated at that time, the content decrypting unit 1521 cannot decrypt the contents because the right content decryption key can not be generated, as a result, the content using unit 1522 cannot decode the contents. The status of decoding error in this case may be notified to the content decrypting unit 1521. By doing this, the content decrypting unit 1521 does not record history logs in the case where the content decoding fails. In other words, the fact that content decoding failed can be recorded as history logs.

Next, history log recording processing shown in the step S2904 in FIG. 29 will be explained with reference to FIG. 3.

The content decrypting unit 1521 temporally records the value of the PCR 1125a (step S3001). More specifically, the content decrypting unit 1521, in the case where the TS packet 1100 where the PCR 1125a is set is processed, obtains the value of the PCR 1125a and temporally records it inside. At this time, the second time information of the Private Data 1125e may be also obtained and temporally recorded inside.

The content decrypting unit 1521 checks whether the status notification from the content using unit 1522 is received or not (step S3002). More specifically, the content decrypting unit 1521 receives the decoding status such as playback, stop, forwarding, rewinding or the content decoding error from the content using unit 1522.

In the case where the answer of the step S3002 is YES, in other words, in the case where the status notification from the content using unit 1522 has already been received, step S3003 is executed.

In the case where the answer of the step S3002 is NO, in other words, in the case where the status notification from the content using unit 1522 has not been received yet, step S3001 is executed.

The content decrypting unit 1521 sends the value of the first time information and the second time information to the time information calculating unit 2801 depending on the status notification from the content using unit 1522 and the time information calculating unit 2801 calculates the starting time information or the ending time information (step S3003). More specifically, the content decrypting unit 1521 obtains the value of the first time information that is temporally recorded and the second time information of the Private Data 1125e of the TS packet 1100 in response to the notification indicating the status sent from the content using unit 1522 and notifies the time information calculating unit 2801 of them. The time information calculating unit 2801 calculates the difference between the value of each pieces of the first time information and the second time information and generates the history logs that specify the viewed part of the contents. For example, history logs are recorded as the starting time information in the case where the content using unit 1522 receives “playback start”, and history logs are recorded as the ending time information in the case where “forwarding” is received.

The content decrypting unit 1521 judges whether the status notification from the content using unit 1522 is “content use end” in other words, “stop” or not (step S3004).

In the case where the answer of the step S3004 is YES, in other words, in the case where the status notification from the content using unit 1522 is “stop”, the recorded history logs (the starting time information and the ending time information) are sent to the history log recording unit 1505 at this time and the processing is finished. Note that the timing for sending the recorded history logs to the history log recording unit 1505 is not limited to the timing of finishing using contents, for example, the recorded history logs may be sent each time a user operation is performed (each time history logs are recorded) at a certain temporal intervals.

In the case where the answer of the step S3004 is NO, in other words, in the case where the status notification from the content using unit 1522 is the one except “stop”, step S3001 is executed.

Next, the processing for sending contents by the content distribution server 101c at the time of content use by the terminal apparatus 102 will be explained with reference to FIG. 31.

The content obtainment request receiving unit 901 in the content distribution server 101c receives the content obtainment request from the terminal apparatus 102 (step S3101). More specifically, the content obtainment request receiving unit 901 receives playback request by the RTSP from the terminal apparatus 102, obtains the requested content ID and sends the content ID to the content obtaining unit 902.

The time information adding unit 2601 temporally stores the second time information (step S3102). More specifically, on receiving the notification indicating that reading out contents from the content obtaining unit 902 is started, the time information adding unit 2601 obtains the value of the STC from the timer unit 907 as the value of the first time information in the head of the contents, in other words, as the second time information, and stores it inside the time information adding unit 2601. The time information adding unit 2601 keeps obtaining the STC from the timer unit 907 and performs processing for supplying the content obtaining unit 902 and the content multiplexing unit 904 with STCs.

The content sending unit 910 judges whether the content sending has finished or not (step S3103). More specifically, the content sending unit 910 judges whether all the contents are sent to the terminal apparatus 102 as the RTP packets or not.

In the case where the answer of the step S3103 is NO, in other words, in the case where the content sending has not been finished yet, step S3104 is executed.

In the case where the answer of the step S3103 is YES, in other words, in the case where the content sending has already been finished, a notification of the fact is sent to the content obtainment request receiving unit 901 and the processing is finished.

The content obtaining unit 902 reads out the contents of the content ID from the content DB 903 (step S3104). More specifically, the content obtaining unit 902 searches the content DB 903 regarding the content ID received from the content obtainment request receiving unit 901 as a key and obtains the contents.

The content obtaining unit 902 and the content multiplexing unit 904 generates the PES packet 1000 and the TS packet 1100 in sequence and adds the first time information and the second time information to the TS packet 1100 (step S3105). More specifically, the content obtaining unit 902 performs MPEG encoding on the video, sound and the like of the contents obtained from the content DB 903 in the step S3104 in sequence and assigns the PTS 1043a and the DTS 1043b for realizing synchronization of the video ES with sound ES to the TS packet 1100 using the STC obtained from the time information adding unit 2601.

Also, the content multiplexing unit 904 transforms the PES packet 1000 obtained from the content obtaining unit 902 into a TS packet. At that time, using the STC obtained from the time information adding unit 2601, it assigns the PCR 1125a for synchronizing the system clock (the STC that is not shown in FIG. 28) in the terminal apparatus 102 with the system clock (STC, in other words, the timer unit 907) of the content distribution server 101c to the TS packet 1100 and also assigns the second time information that is temporally stored in the Private Data 1125e to the TS packet 1100. Further, the content multiplexing unit 904 generates the PSI (such as PAT, PMT) and other TS packet 1100 such as null packets and multiplexes them with the TS packet 1100 of the contents.

After decrypting the TS packet 1100 using a content key, the content encrypting unit 905 and the content sending unit 910 generates the RTP packet and sends it to the terminal apparatus 102 (step S3106). More specifically, the content encrypting unit 905, in the case where the PCR 1125a is included in the TS packet 1100 received from the content multiplexing unit 904, generates the encryption key for encrypting the payload by performing XOR on the first time information (PCR 1125a), the second time information of the Private Data 1125e and the content key received from the content key supplying unit 906 and encrypts the payload part (TSP Payload 1130) of the TS packet 1100. In the case where no PCR 1125a is included in the TS packet 1100, using only the content key received from the content key supplying unit 906, it encrypts the payload part (TSP Payload 1130) of the TS packet 1100.

Also, the content key supplying unit 906 receives the content ID of the contents to be sent from the content obtainment request receiving unit 901 to the terminal apparatus 102, reads out the corresponding content key from the content key DB 911 and passes it along with the content PID to the content encrypting unit 905. The content PID at this time is used for identifying the TS packet 1100 that is encrypted by the content encrypting unit 905 and the PID specified by the content multiplexing unit 904 is passed.

Also, the content sending unit 910 divides (or aggregates) the encrypted TS packet 1100 received from the content encrypting unit 905 into pieces at a certain size, adds an RTP header to each of them, generates the RTP packets and sends them to the terminal apparatus 102 in sequence. After that, the step S3103 is executed.

Up to this point, explanation on the operation for sending contents in the content distribution server 101c at the time of using streaming contents in the terminal apparatus 102 has been finished.

As explained above, in the content history log collecting system 2, the first time information generated in the distribution center 101 and the second time information that is the value of the first time information in the head of the contents is securely bound and distributed to the terminal apparatus 102, and the terminal apparatus 102 calculates which part of the contents is used by a user based on the first time information and the second time information. Therefore, the content provider and the service provider can obtain user history logs in detail and securely and reduce the processing of the history log collecting server 101e at the time of collecting history logs. Also, a system for exchanging the second time information between the content distribution server 101c and the history log collecting server 101e becomes unnecessary and thus the system of the distribution center 101 becomes more flexible.

In this embodiment of the present invention, here is shown an example where the first time information and the second time information are set in the PCR 1125a of the TS packet 1100 and the Private Data 1125e, but the present invention is not limited to this, it is possible to set time information capable of identifying the used part of the contents such as the first time information and the second time information using the PTS 1043a, the DTS 1043b of the PES packet 1000 and the PES Private Data 1081. Also, the MPEG-2, the MPEG-4 AVC or the like are conceivable as video and sound set in the PES packet, but they are not limited to these.

In this case, the PES packet 1000 itself is divided into appropriate sizes and they are set in the TSP Payload 1130 of the TS packet 1100 so as to be encrypted, the time information of the PES packet 1000 (time information set in the PTS 1043a, the DTS 1043b and the PES Private Data 1081) is bound to the contents securely. Therefore, as a special processing for binding the first time information and the second time information with the contents securely except the encrypting processing of the contents (TS packet 1100) becomes unnecessary in the content distribution server 101c, there is an effect of reducing the workload of the content distribution server 10c.

Further, in order to record viewing history capable of identifying viewed parts securely using the PTS or the DTS as shown above, it is desired that a decoding error (decoding status such as overflows of the decoding buffer) in the MPEG decoder in the terminal apparatus 102 (content using unit 1522) be detected and viewing history be not recorded in the case where a decoding error is detected. This is because the PTS and the DTS are simply encrypted and no manipulation on the PTS and the DTS can be detected.

Also, in the embodiment of the present invention, in the history log collecting server 101e or the terminal apparatus 102, an example where the relative time from the head of the contents that is capable of identifying the used part of the contents is calculated based on the value of the first time information recorded in the terminal apparatus 102 as the history logs and the second time information, but it is also possible to previously calculate the relative time from the head of the contents based on the first time information and the second time information in the content distribution server 101c and record the time information set in the contents in the terminal apparatus 102 as they are by setting this in the contents. According to this, it is possible to reduce the workloads of the terminal apparatus 102 in the history log recording processing and the history log collecting server 101e in the history log collecting processing.

At this time, the relative time from the head of the contents can be set in the PES Private Data 1081 of the PES packet or the Private Data 1125e of the TS packet 1100. Also, in the case where the relative time from the head of the contents is set in the Private Data 1125e of the TS packet 1100, it is possible to bind it securely to the payload part (TSP Payload 1130) of the TS packet 1100 using the earlier mentioned method. Also, as the time information such as the PCR 1125a and the PTS 1043a/the DTS 1043b is necessary for playing back the STC or decoding and playing back contents, it is needless to say that they are added to the TS packet 1100 and the PES packet 1000. Therefore, history log recording processing during the special playback that is explained in the first embodiment and the second embodiment of the present invention is applicable in this case.

At that time, in the MPEG decoder (content using unit 1522), in the case where the continuity of the time stamp is judged (whether the change in value is within a certain range) to be not continuous, it is possible to stop recording history logs. In this way, in the case where time stamps at the time of viewing start and end are recorded as history logs, it is possible to avoid recording unauthentic history logs in the case where part of the contents is altered in the midway.

This is an effective method in the case where there is a risk that the order of TS packets is switched by intercepting contents distributed from the distribution center 101 on the network 103 or the order of TS packets is switched in the content storing unit in the terminal device 102 that is not shown in FIG. 15.

Also, instead of recording time stamps at the time of viewing start and end as history logs, it is possible to record time stamps at the time of viewing start and viewing time.

Also, in the embodiment of the present invention, the value of the PCR 1125a of the head of the contents (the second time information) is recorded in the distribution center 101, but, for example, it is also possible to record the map where the value of the PCR 1125a of all the contents is recorded because only the value of the second time information is needed. Also, it is possible to send this map in the terminal apparatus 102 and generate the information for specifying the used part of the contents using this map in the terminal apparatus 102. In other words, in the embodiment of the present invention, an example Where time information for recording history logs is set in the contents, but the present invention is not limited to this, it is also possible to distribute it separately from the contents. Also, it is needless to say that it is also possible to store the contents itself in the distribution center 101 or the terminal device 102 and generate the information identifying the used part of the contents instead of recording and storing time information in the head of the contents in the distribution center 101 or the terminal device 102. Also, in the case where it is possible to practically secure the security of the MPEG decoder (content using unit 1522) of the terminal device 102 according to a method such as the method of making the MPEG decoder tamper-proofed on condition that the PCR 1125a of the non-encrypted part of the contents is used as time information, a method for not explicitly and securely binding the PCR 1125a to the encrypted part of the contents is conceivable. This is because it is indirectly and securely bound to the PTS 1043a/DTS 1043b included in the encrypted part of the contents via the STC of the MPEG decoder.

Also, in the embodiment of the present invention, an example where contents are distributed from the content distribution server 101c in a stream, but the present invention is not limited to this, it can be download contents stored in the memory in the terminal apparatus 102 or on the network 103 (including stored streaming contents).

Also, a license ID 1706 that is an ID for specifying the LT 700 as the UL 1700 that is a history log is set in the embodiment of the present invention, but it is also possible to set the use condition ID (use condition ID 502 of the use condition management table 500) that is managed in the right management server 101b. In this case, the right management server 101b needs to add the use condition ID 502 to the LT 700 when issuing the LT 700. The terminal apparatus 102 can set the use condition ID 502 in the UL 1700 using the use condition ID 502 set in the UR 1700.

Also, the embodiment of the present invention shows an example where a SAC with PKI is used when the terminal apparatus 102 sends the UL 1700 to the history log collecting server 101e, no mutual authentication is used, a secure communication channel between the history log collecting server 101e and the terminal apparatus 102 is used, but it is also possible to encrypt the UL 1700 using a content key and send it.

Also, a history log is set as a UL 1700 and sent from the terminal apparatus 102 to the distribution center 101 in the embodiment of the present invention, but the present invention is not limited to this, it is also possible to send a history log from the terminal apparatus 102 to the distribution center 101 by using the LT 700 at returning timing of the LT 700 from the terminal apparatus 102 to the distribution center 101.

Also, time information is used as the information capable of identifying the used part of the contents in this embodiment of the present invention, but the present invention is not limited to this, naturally, it is also possible to use location information except time information as long as the information is the one capable of grasping the viewed part in the contents securely and uniquely. Further, it is also possible to send, from the terminal apparatus 102 to the history log collecting server 101e, the whole TS packet 1100 including at least unique information (PCR 1125a, PTS 1043a or the like) in the contents or the whole PES packet 1000 besides the location information as history logs. In this way, it is possible to reduce the workload of the content distribution server 101c in the sending processing and the workload of the terminal apparatus 102 in the history log collecting processing. In addition, it is possible to use other methods as long as it is the one capable of grasping which part of the contents is used such as the one for recording history logs at the time of starting and ending time of using the contents based on the starting time of using contents and the duration time even in the case where time information is used.

Also, whether history logs are obtained in the content decrypting unit 1521 of the terminal apparatus 102 or not is judged in the embodiment of the present invention, it is also possible to perform processing for judging whether history logs are obtained in the content using unit 1522 or not. In this case, the section information obtained as history logs is sent from the content using unit 1522 to the section information recording unit 1523. Also, the same processing can be done in the second embodiment of the present invention (FIG. 28).

Also, here is shown an example where target users whose history logs are to be collected are dynamically determined by the right management server 101b in the embodiment of the present invention, previously determining the target users whose history logs are to be collected makes it possible to statically determine the target users whose history logs are to be collected. In this case, a table where target users are recorded may be stored in the database unit in the right management server 101b.

Also, an example case where the distribution center 101 is composed of a plurality of server apparatuses in the embodiment of the present invention, but the present invention is not limited to this, for example, it can also be realized in a structure of a single server apparatus that has a plurality of functions.

Also, here is shown an example where history logs are collected for each terminal apparatus 102 in the embodiment of the present invention, but for example, it is also possible to collect history logs for each home server or for each channel server of the logical or physical network such as home network.

Further, here is shown an example where contents, licenses, history logs and the like are obtained via a single distribution channel in this embodiment of the present invention, it is also possible to obtain them via multiple distribution channels, for example, via both digital broadcasting and the Internet or via a package medium and the Internet.

### INDUSTRIAL APPLICABILITY

The present invention is suitable for a digital content distribution system where a server apparatus for providing a terminal apparatus with a license for using contents and the terminal apparatus for controlling the content use based on the license obtained from the server apparatus. For example, the system is suitable for server apparatuses such as a distribution server of the service provider for distributing digital contents via the Internet and a broadcasting device for broadcasting the digital contents digitally via broadcasting. Also, the system is suitable for terminal apparatuses such as a set top box for receiving digital broadcast, a content playback device such as a digital TV, a DVD recorder, a hard disc recorder and a personal computer, a storage device, a device where some of those devices are multiplexed or the like.

What is claimed is:

1. A content history log collecting system comprising a server apparatus for distributing a content to a terminal apparatus and collecting a content history log from the terminal apparatus and a terminal apparatus for using the content,
wherein the server apparatus includes:
an adding unit operable to add, to the content, time information indicating a temporal scale of the content; and
a content sending unit operable to send, to the terminal apparatus, the content to which the time information is added, and
the terminal apparatus includes:
a content using unit operable to use the content sent from the server apparatus;
a generating unit operable to generate section information indicating a section in the content that has been actually used by the content using unit based on the time information of the content; and
a sending unit operable to send the section information to the server apparatus.

2. The content history log collecting system according to claim 1,
wherein the generating unit includes:
a first detecting unit operable to detect a value of time information obtained when the content using unit starts using the content as starting time;
a second detecting unit operable to detect a value of time information obtained when the content using unit finishes using the content as ending time; and
a creating unit operable to create the section information based on the starting time detected by the first detecting unit and the ending time detected by the second detecting unit.

3. The content history log collecting system according to claim 2,
wherein the time information is added as any of following data:
(a) program clock reference in transport stream packets;
(b) presentation time stamp in PES packets;
(c) decoding time stamp in PES packets
(d) private data in transport stream packets; and
(e) private data in PES packets.

4. The content history log collecting system according to claim 3,
wherein the server apparatus further includes a content encrypting unit operable to encrypt at least part of the content, and
the terminal apparatus further includes:
a content decrypting unit operable to decrypt the encrypted content; and
the content using unit uses the decrypted content.

5. The content history log collecting system according to claim 4,
wherein the server apparatus further includes a binding unit operable to bind the time information to the content securely.

6. The content history log collecting system according to claim 5,
wherein the adding unit adds the time information at least to the encrypted part of the content.

7. The content history log collecting system according to claim 5,
wherein the adding unit adds the time information at least to non-encrypted part of the content, and
the binding unit adds, to the content, a hash value of the time information and at least part of the content.

8. The content history log collecting system according to claim 7,
wherein the content decrypting unit performs an error detection based on the hash value and stops decrypting the content in the case where an error is detected.

9. The content history log collecting system according to claim 7,
wherein the content decrypting unit performs an error detection based on the hash value, and the generating unit stops generating the section information in the case where an error is detected.

10. The content history log collecting system according to claim 9,
wherein the terminal apparatus further includes a collecting unit operable to collect a content history log except the section information, and
the collecting unit generates the content history log indicating that the time information is manipulated in the case where the error is detected.

11. The content history log collecting system according to claim 5,
wherein the adding unit adds the time information at least to the non-encrypted part of the content,
the binding unit generates a new encryption key associating the time information with an encryption key of the content, and
the content encrypting unit encrypts the content using the new encryption key.

12. The content history log collecting system according to claim 5,
wherein the adding unit adds the time information at least to the non-encrypted part of the content, and
the binding unit sets the time information as an initial parameter for encrypting performed by the content encrypting unit.

13. The content history log collecting system according to claim 5,
wherein, the content decrypting unit instructs the generating unit not to generate the section information in one of the case where the content decrypting unit fails to decrypt the content and the case where the content using unit fails to play back the content.

14. The content history log collecting system according to claim 5,
wherein the terminal apparatus further includes a collecting unit operable to collect a content history log except the section information, and
the content decrypting unit instructs the collecting unit to record a history log indicating that the decryption failed in one of the case where the content decrypting unit fails to decrypt the content and the case where the content using unit fails to play back the content.

15. The content history log collecting system according to claim 2,
wherein the generating unit generates the section information excluding the special playback section in the case where content special playback is performed in the content using unit.

16. The content history log collecting system according to claim 2,
wherein the terminal apparatus further includes a collecting unit operable to collect a content history log except the section information, and
the colleting unit, in the case where content special playback is performed in the content using unit, records a history log indicating that the special playback is performed.

17. The content history log collecting system according to claim 16,
wherein the collecting unit, when the content is being used in the content using unit, obtains the values of time information in sequence and detects that special playback is being performed on the content based on a difference of said values spaced at certain distances.

18. The content history log collecting system according to claim 16,
wherein the content using unit, when special playback is being performed on the content, notifies the collecting unit that special playback is being performed.

19. The content history log collecting system according to claim 2,
wherein the sending unit sends a license ID concerning the content to the server apparatus together with the section information.

20. The content history log collecting system according to claim 2,
wherein the sending unit sends a use condition ID concerning the content to the server apparatus together with the section information.

21. The content history log collecting system according to claim 2,
wherein the server apparatus further includes:
a holding unit operable to hold the value of time information in a content head as head time; and
a specifying unit operable to specify a section for use obtained as a relative location with respect to the content head based on the section information and the head time sent from the terminal apparatus.

22. The content history log collecting system according to claim 2,
wherein the adding unit adds, to the content, the value of the time information in a content head as head time,
the creating unit specifies a section for use obtained as a relative location with respect to the content head based on the head time, the starting time and the ending time, and
the section information indicates the specified section for use.

23. The content history log collecting system according to claim 2,
wherein the adding unit adds, to a content, the time information that has at least a value obtained as relative time from the content head,
the creating unit specifies a section for use obtained as a relative location with respect to the content head based on the starting time and the ending time, and
the section information indicates the specified section for use.

24. A server apparatus for distributing a content to a terminal apparatus and collecting a content history log from the terminal apparatus, including:
an adding unit operable to add, to the content, time information indicating a temporal scale of the content;
a content sending unit operable to send, to the terminal apparatus, a content to which time information is added; and
a receiving unit operable to receive section information indicating a section in the content that has been actually used in the terminal apparatus based on values of the time information.

25. A terminal apparatus for using a content distributed from a server apparatus, including:
a content using unit operable to use a content to which time information indicating a temporal scale of the content is added;
a generating unit operable to generate section information indicating a section of the content that has been actually used by the content using unit based on the time information of the content; and
a sending unit operable to send the section information to the server apparatus.

26. A content history log collecting method in a content history log collecting system comprising a server apparatus for distributing a content to a terminal apparatus and collecting a content history log from the terminal apparatus and the terminal apparatus for using the content, the method comprising:
an adding step of adding, to the content, time information indicating a temporal scale of the content in the server apparatus;
a content using step of using the content sent from the server apparatus in the terminal apparatus;
a generating step of generating, in the terminal apparatus section information indicating a section in the content that has been actually used by the content using unit based on time information of the content; and
a sending step of sending the section information from the terminal apparatus to the server apparatus.

27. A history log collecting method performed in a server apparatus for distributing a content to the terminal apparatus and collecting a content history log from the terminal server, the method comprising:
an adding step of adding, to the content, time information indicating a temporal scale of the content;
a content sending step of sending, to the terminal apparatus, the content to which time information is added; and
a receiving step of receiving section information indicating a section in the content that has been actually used in the terminal apparatus based on a value of time information.

28. A history log collecting method performed in a terminal apparatus that uses a content distributed from a server apparatus, comprising:
a content using step of using a content to which time information indicating a temporal scale of the content is added;
a generating step of generating section information indicating a section in the content that has been actually used in the content using step based on the time information of the content; and
a sending step of sending the section information to the server apparatus.

29. A program for causing a computer to execute distributing a content to a terminal apparatus and collecting a content history log from the terminal apparatus, the program comprising:
an adding step of adding, to the content, time information indicating a temporal scale of the content;
a content sending step of sending, to the terminal apparatus, a content to which time information is added; and
a receiving step of receiving section information indicating a section in the content that has been actually used in the terminal apparatus based on a value of time information.

30. A program for causing a computer to execute collecting a history log in a terminal apparatus that uses a content distributed from a server apparatus, the program comprising:
a content using step of using a content to which time information indicating a temporal scale of the content is added; and
a generating step of generating section information indicating a section in the content that has been actually used by the content using unit based on time information of the content.
